(19) United States
(12) Patent Application Publication
(10) Pub. No.: US 2016/0358190 A1
(43) Pub. Date: Dec. 8, 2016

(54) METHODS AND APPARATUS TO ESTIMATE A POPULATION OF A CONSUMER SEGMENT IN A GEOGRAPHIC AREA

(71) Applicant: The Nielsen Company (US), LLC, New York, NY (US)

(72) Inventors: Alejandro Terrazas, Santa Cruz, CA (US); Peter Lipa, Tucson, AZ (US); Wei Xie, Woodridge, IL (US); John Charles Torres, San Diego, CA (US)

(21) Appl. No.: 14/866,435

(22) Filed: Sep. 25, 2015

Related U.S. Application Data
(60) Provisional application No. 62/171,053, filed on Jun. 4, 2015.

(51) Int. Cl. G06Q 30/02; G06K 9/62; G06F 17/30; G06T 7/00

(52) U.S. Cl. CPC G06Q 30/0201; G06T 7/0004; G06K 9/6215; G06K 9/6267; G06F 17/30241; G06T 2207/30181; G06T 2207/20021

(57) ABSTRACT

Methods and apparatus to estimate a population of a consumer segment in a geographic area are disclosed. An example method includes: recognizing a first type of object in a first image of a first area, the first type of object being associated with a consumer segment; obtaining first measurements of a first set of characteristics for the first area, the first set of characteristics being associated with the segment; determining a first relationship between a first population of the segment in the first area and the first measurements of the first set of characteristics; recognizing the first type of object in a second image of a second area; obtaining second measurements of a second set of characteristics for the second area; and determining a second population of the segment in the second area based on applying the first relationship to the second measurements.

### RELATED APPLICATIONS

This patent claims priority to U.S. Provisional Patent Application Ser. No. 62/171,053, filed Jun. 4, 2015, entitled “Methods and Apparatus to Estimate a Population of a Consumer Segment in a Geographic Area.” The entirety of U.S. Provisional Patent Application Ser. No. 62/171,053 is incorporated herein by reference.

### FIELD OF THE DISCLOSURE

This disclosure relates generally to commercial surveying, and, more particularly, to methods and apparatus to estimate a population of a consumer segment in a geographic area.

### BACKGROUND

Manufacturers and/or distributors of goods and/or services sometimes wish to determine where new markets are emerging and/or developing. Smaller, growing markets are often desirable targets for such studies. As these markets grow larger and/or mature, previous market research becomes obsolete and may be updated and/or performed again.

### BRIEF DESCRIPTION OF THE DRAWINGS

FIG. 1 is a block diagram of an example consumer segment determiner constructed in accordance with the teachings of this disclosure to estimate a consumer segment for a geographic area.

FIG. 2 is a block diagram of an example implementation of the example measurement collector of FIG. 1.

FIG. 3 is an example aerial image that may be analyzed by the example measurement collector of FIGS. 1 and/or 2 to measure a characteristic of a geographic area.

FIG. 4 is an example ground level image that may be analyzed by the example measurement collector of FIGS. 1 and/or 2 to measure a characteristic of a geographic area.

FIG. 5 shows an example geographic area that may be searched by the example measurement collector of FIGS. 1 and/or 2 to measure activities as a characteristic of the geographic area.

FIG. 6 is a table of example economic information that may be collected and analyzed by the example measurement collector of FIGS. 1 and/or 2 to measure sales information as a characteristic of a geographic area.

FIG. 7 is a table of example sales information that may be collected and analyzed by the example measurement collector of FIGS. 1 and/or 2 to measure sales information as a characteristic of a geographic area.

FIG. 8 is a block diagram of an example implementation of the example segment modeler of FIG. 1.

FIG. 9 is a graphical representation of an example map of an estimated population for a geographic area within a specified consumer segment, which is generated by the example segment estimator of FIG. 1.

FIG. 10 is a flowchart representative of example machine readable instructions which may be executed to implement the example consumer segment determiner of FIG. 1 to estimate a consumer segment in a geographic area.

FIG. 11 is a flowchart representative of example machine readable instructions which may be executed to implement the example segment modeler of FIG. 1 to collect measurements of a set of characteristics for a geographic area.

FIG. 12 is a flowchart representative of example machine readable instructions which may be executed to implement the example consumer segment determiner of FIG. 1 to determine a relationship between a population of a consumer segment and collected measurements of a set of characteristics.

FIG. 13 is a block diagram of another implementation of the example segment modeler of FIG. 1 that may be used to generate a consumer segment model based on characteristic measurements from the example measurement collector of FIG. 1.

FIG. 14 is a flowchart representative of example machine readable instructions which may be executed to implement the example consumer segment determiner of FIG. 1 to determine a relationship between a population of a consumer segment and collected measurements of a set of characteristics.

FIG. 15 is a block diagram of an example processor platform capable of executing the instructions of FIGS. 10, 11, and/or 12 to implement the example consumer segment determiner 100 of FIGS. 1, 2, and/or 8.

FIG. 16 is a block diagram of an example processor platform capable of executing the instructions of FIGS. 10, 11, and/or 14 to implement the example consumer segment determiner 100 of FIGS. 1, 2, and/or 13.

The figures are not to scale. Wherever appropriate, the same reference numbers will be used throughout the drawing(s) and accompanying written description to refer to the same or like parts.

### DETAILED DESCRIPTION

Examples disclosed herein estimate a population that belongs to one or more specified consumer segments within a geographic area of interest. To generate such an estimate, some disclosed examples gather data indicating behavior associated with the product or service of interest from multiple data sources. In some such examples, these data also include geospatial, or location-based, components. That is, the data are related to a particular location or area. Example data sources include databases of aerial and/or ground level images, activity databases, surveys, points of interest, databases of store information and/or sales information, and/or databases of economic information, among others. In some examples, data sources are derived from the same greater geographic region as the geographic area(s) for which classification is desired, in a similar geographic region as the geographic area(s) for which classification is desired, and/or anywhere such data sources are available.

Examples disclosed herein gather geocoded digital photographs and/or download freely available geocoded digital photographs from areas of interest. Disclosed examples extract color, texture and object features from the digital photographs. Disclosed examples also gather satellite features and point of interest data from the area of interest, and use machine learning techniques and ground truth to identify and/or estimate the presence or prevalence of consumer segments in the area of interest. For example, the presence of objects such as a basketball hoop and/or a recreational vehicle (e.g., in an image and/or from manual sampling) may be used to build a geostatistical model of demographics (or consumer segment information) for the area in which the objects were identified.

Two different residential properties can look very similar from an aerial image. However, a photograph of one residence (e.g., a geotagged photo, including metadata revealing the location at which the photo was taken) that reveals an unkempt lawn and rusty tools strewn about may be compared to a second photograph (e.g., a geotagged photograph) taken near the other residence, in which a manicured lawn and some children's toys are found. The differences in the features in the photo can be used in combination with neighborhood relationships to add information to image features identified from satellite photos.

Disclosed examples combine features obtained from both aerial views and ground level views to determine segment information. Some disclosed examples use a “forest-and-trees” approach, in which analysis of aerial images can provide information about the “forest,” or macro-level characteristics, and analysis of the ground level images can provide information about individual “trees,” or more detailed characteristics about specific points or locations. For example, aerial images can be analyzed to extract macro-level information about an area and/or identifiable objects. Ground level images are obtained for points (i.e., locations) on the surface that are within the area covered by the aerial view, and can analyzed to extract additional features and/or characteristics that are not identifiable from the aerial image.

From image-based data sources, disclosed examples extract visually observable features such as the presence of identifiable objects. Some disclosed examples extract visually observable features from satellite imagery and extract visually observable features from digital photos such as Google Street View photos and/or other publicly available photos having geographic metadata. The presence and/or quantities of visually observable features are used as characteristics to describe the geographic areas in which the features are observed (or not observed). As used herein, the term “visually observable” is defined to mean capable of observation by a human within an image, such as an aerial image or ground-level image. For example, a visually observable feature may be machine-observable in an image despite not being observable by a person without the aid of a device that converts information falling outside of human perception into information that is capable of human observation. An example of such information conversion may be features in an infrared image, which is an image generated by converting infrared information captured by an infrared camera into the visible light spectrum.

As an example, a retirement community may appear to be a mostly homogenous area based on analysis of an aerial image taken of the retirement community. In the example, ground level images are also obtained from locations within the retirement community from which types and numbers of objects can be identified using, for example, computer vision techniques. In this example, the analyses of the ground level images reveal the presence of 2 tandem bikes, 4 recreational vehicles, and 3 toddler-size basketball hoops. Segment information corresponding to this mix of objects can be applied, based on an observation of relative homogeneity in an aerial image of the retirement community, to the entire retirement community. When a subsequent retirement community that looks like the first one is analyzed (e.g., either in the same city or a different city), examples disclosed herein apply one or more identified segments from the first retirement community to the second retirement community.

Some examples disclosed herein measure one or more characteristics of a geographic area using aerial (e.g., satellite) images. As used herein, the term “aerial image of interest” refers to aerial images that include a specified geographic area (e.g., area of interest) and/or to aerial images of areas associated with (e.g., nearby), but not including, the specified geographic area (e.g., area of interest).

Examples disclosed herein detect some types of characteristics or features of a geographic area using computer vision techniques, which may be combined with and/or verified via manual identification. For example, a computer or other machine may be provided with examples of objects that are to be identified and/or counted in a set of images of a geographic area. Such examples may include typical aerial views of the objects and/or ground level views of the objects. As used herein, the term “aerial view” refers to a view that is completely or primarily overhead. Aerial viewing allows for the viewer not being directly above the object. As used herein the term “ground view” refers to a view that is at or near ground level such that the view of an object that is also on or near the ground is a completely or primarily lateral view. For example, an image taken by a person standing at or near ground level (e.g., on the ground, on a ladder, from a second-floor window of a building) would be considered a ground view image unless stated otherwise. An image taken by an aircraft or satellite passing over the area around the object would be considered an aerial view. Images of an object that are between aerial views and ground views (e.g., an image taken from a higher story of a building, images taken between a 30° angle and a 60° angle with respect to ground, etc.) that partially captures a profile of an object and partially captures an overhead view of the object may be considered either aerial views or ground views, depending on the recognizable features of the object that are captured in the image.

Computer vision is a technical field that involves processing digital images in ways that mimic human processing of images. Disclosed example methods and apparatus solve the technical problems of accurately categorizing and/or matching aerial images using combinations of computer vision techniques and/or other geospatial data. Disclosed example techniques use computer vision to solve the technical problem of efficiently processing large numbers of digital images to find an image that is considered to match according to spatially distributed sets of features within the image.

Consumer segmentation refers to the classification of consumers into descriptive groups or buckets. As an example of consumer segmentation, the Nielsen PRIZM® lifestyle segmentation system includes 66 demographically and behaviorally distinct types, or “segments,” to help marketers discern those consumers' likes, dislikes, lifestyles and purchase behavior. Any segmentation system and/or number of segments may be used, and a segmentation system may change over time to add, drop, and/or change segment definitions. The 66 segments of the PRIZM® system are grouped into 11 lifestage groups and 14 social groups. PRIZM® social groups are based on urbanization and socioeconomic rank. PRIZM® lifestage groups are based on age, socioeconomic rank, and the presence of children at home. In some examples, consumer segments are associated with purchase behavior includes purchases of apparel, appliances, automobiles, communications equipment and/or services, consumer package goods, financial services, home furnishings, media usage, and/or travel. In some examples, consumer segments are associated with media behavior (e.g., media consumption) such as television, cable, internet, radio, newspaper, and magazine media.

Disclosed examples improve consumer segmentation techniques by: identifying geographically-linked information by using computer vision techniques to identify objects from ground-based images and/or aerial images of a geographic area; identifying relationships and/or modeling the geographically-linked information to link the geographically-linked information to consumer segments; and apply the relationships to other geographic areas to determine the consumers segments represented in those areas based on identified geographically-linked information. Examples disclosed herein enable rapid identification of consumer segments in unknown areas and/or changes to consumer segments in previously-measured areas. Some examples accomplish the consumer segment estimation of a geographic area without manual surveying or sampling of that area, thereby improving the coverage of consumer segment measurement.

Disclosed example methods include recognizing, using a first computer vision technique, a first type of object in a first image of a first area, the first type of object being associated with a consumer segment. The disclosed example methods further include obtaining first measurements of a first set of characteristics for the first area, where the first set of characteristics are associated with the consumer segment and including the first type of object. The disclosed example methods further include determining a first relationship between a first population of the consumer segment in the first area and the first measurements of the first set of characteristics. The disclosed example methods further include recognizing, using at least one of the first computer vision technique or a second computer vision technique, the first type of object in a second image of a second area. The disclosed example methods further include obtaining second measurements of a second set of characteristics for the second area, where the second set of characteristics include the first type of object. The disclosed example method further include estimating a second population of the consumer segment in the second area based on applying the first relationship to the second measurements.

In some examples, the first image is a ground-level image of a point of interest within the first area, where the recognizing of the first type of object includes recognizing the first type of object that is not recognizable from an aerial view of the point of interest. Some such example methods further include recognizing a second type of object in an aerial image of the first area, where the second type of object is associated with the consumer segment, and obtaining third measurements of the first set of characteristics for the first area. In the example methods, the first set of characteristics are associated with the consumer segment and including the second type of object, and the determining of the first relationship between the first population of the consumer segment in the first area and the first measurements of the first set of characteristics is based on the third measurements.

In some example methods, the determining of the first relationship includes looking up a combination of objects, including the first type of object, in a database of consumer segment information. Some example methods further include identifying a set of second objects in an aerial image of the first area, where the second objects in the set share a common feature identifiable in the aerial image. Such example methods further include determining a similarity metric between the second objects in the set and classifying the first area based on the similarity metric, where the determining of the first relationship is based on a classification of the first area.

In some examples, determining the first relationship includes estimating a third population in the first area that belongs to a first lifestage group, estimating a fourth population in the first area that belongs to a first social group, and weighting the third population and the fourth population to determine the first relationship. In some such examples, estimating the third population includes estimating a number of people having a specified affluence, a specified age, and a specified children status, where the first lifestage group is one of a plurality of non-overlapping lifestage groups. In some examples, estimating the third population includes determining a distribution of people into the lifestage groups.

In some disclosed example methods, estimating the fourth population includes estimating a number of people having a specified affluence and a specified urbanicity, where the first social group being one of a plurality of non-overlapping social groups.

Some disclosed examples further include identifying, in the first image, multiple objects having different respective object types, and determining one of multiple consumer segments that most closely matches the multiple objects based on respective sets of objects associated with the consumer segments, where determining the first relationship is based on the one of the consumer segments.

Disclosed example apparatus includes a measurement collector, a segment modeler, and a segment estimator. The measurement collector recognizes, using a first computer vision technique, a first type of object in a first image of a first area, where the first type of object is associated with a consumer segment. The measurement collector also obtains first measurements of a first set of characteristics for the first area. The first set of characteristics is associated with the consumer segment and includes the first type of object. The measurement collector recognizes, using at least one of the first computer vision technique or a second computer vision technique, the first type of object in a second image of a second area. The measurement collector obtains second measurements of a second set of characteristics for the second area, where the second set of characteristics includes the first type of object. The segment modeler determines a first relationship between a first population of the consumer segment in the first area and the first measurements of the first set of characteristic. The segment estimator estimates a second population of the consumer segment in the second area based on applying the first relationship to the second measurements.

In some examples, the measurement collector includes an aerial image analyzer to recognize the first type of object, where the first image is an aerial image of the first area. In some such examples, the measurement collector includes a ground level image analyzer to recognize, using at least one of the first computer vision technique, the second computer vision technique, or a third computer vision technique, a second type of object in a third image of the first area. The segment modeler determines a second relationship between the consumer segment and a combination of the first type of object and second type of object.

In some examples, the aerial image analyzer and the ground level image analyzer are, in cooperation, to: identify a set of second objects in the first image of the first area and a third image of the first area, where the second objects in the set share a common feature identifiable in the aerial image; determine a similarity metric between the second objects in the set; and classify the first area based on the similarity metric, where the determining the first relationship is based on a classification of the first area.

In some example apparatus, the segment modeler includes a lifestage modeler to generate a lifestage model that describes a relationship between the first measurements and at least one of a specified affluence, a specified age group, or a specified children status of the first population in the first area. In some such examples, the lifestage modeler generates the lifestage model to include a distribution of a third population into multiple affluence groups, multiple age groups, and multiple children statuses.

In some examples, the segment modeler includes a social modeler to generate a social model that describes a relationship between the first measurements and at least one of a specified affluence or a specified urbanicity of the first population in the first area. In some such examples, the social modeler generates the social model to include a distribution of a third population into multiple affluence groups and multiple urbancity groups.

In some examples, the segment modeler determines the first relationship based on distance from a geographic location of at least one of an identified object, an identified activity, or sales information and the first population of the consumer segment. In some example apparatus, the first image of the first area is a commercial street view image and the second image of the second area is obtained from a photo sharing web site, where the first image and the second image including geographic information.

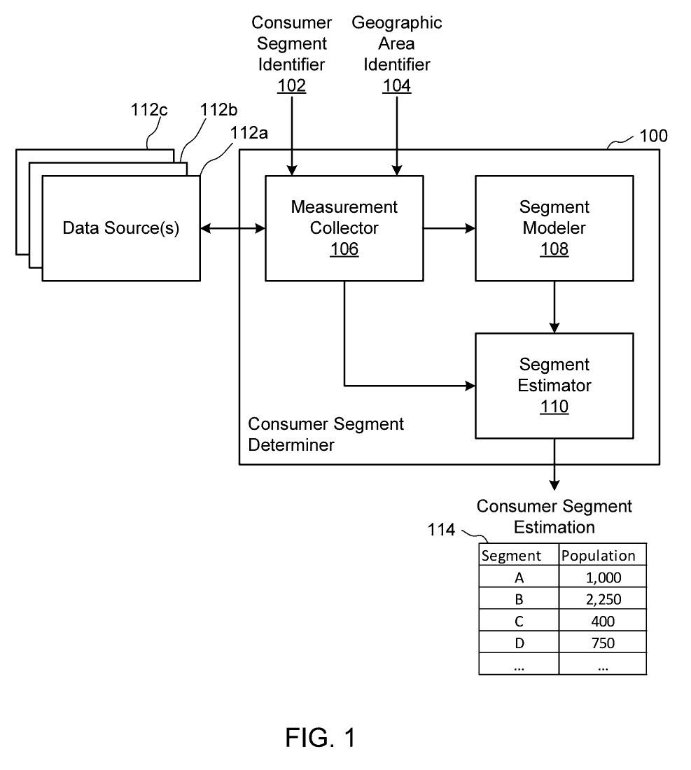

FIG. 1 is a block diagram of an example consumer segment determiner 100 to estimate a consumer segment for a geographic area. Generally, the example consumer segment determiner 100 of FIG. 1 receives an identification of an consumer segment 102 and an identification of a geographic area 104. The consumer segment determiner 100 measures characteristics of the corresponding geographic area, and estimates the corresponding consumer segment within the geographic area (e.g., the population of persons within the consumer segment corresponding to the input consumer segment identifier 102) using the measured characteristics and a relationship between the characteristics and the consumer segment. The example consumer segment determiner 100 of FIG. 1 includes a measurement collector 106, a segment modeler 108, and a segment estimator 110. The structure and operation of an example implementation of the example consumer segment determiner 100 are described in more detail below.

The example measurement collector 106 of FIG. 1 collects measurements of characteristics for geographic area(s), including area(s) from which a segment model (e.g., a predictive model) is developed and area(s) in which the segment model is to be applied (e.g., to estimate the consumer segment). For example, during a model development phase the measurement collector 106 collects first measurements of a set of characteristics for first areas. The model development phase may further include collecting ground truth (e.g., actual measurements) from the first areas. Then, during a segment evaluation phase the measurement collector 106 collects second measurements of the set of characteristics for a second area. The characteristics measured by the measurement collector 106 are selected based on an association between collectable data and the specified consumer segment 102.

The example measurement collector 106 of FIG. 1 collects the measurements of the characteristics from one or more data sources 112a-112c. As described in more detail below, the example data sources 112a-112c may include aerial images, ground level images, surveys (e.g., electronic, personal, telephonic, etc.), economic data, activity data, sales data, and/or other data sources. The example measurement collector 106 may collect measurements from multiple areas in which the demand for the consumer segment corresponding to the identifier 102 is known. Multiple areas are then used to create and/or refine the segment model (e.g., via the segment modeler 108).

The example measurement collector 106 provides collected measurements of the characteristics to the segment modeler 108. The example segment modeler 108 of FIG. 1 determines a relationship between 1) surveyed characteristics (e.g., characteristics obtained by manually counting, sampling, and/or surveying) of a population in a consumer segment (e.g., a consumer segment of interest) and 2) the first measurements of the set of characteristics obtained from the measurement collector 106. In some examples, the segment modeler 108 of FIG. 1 generates sub-models for different aspects of the relationship. For example, the segment modeler 108 may generate a sub-model for each type of characteristic that is measured, and/or for combinations of the characteristics.

The example segment estimator 110 of FIG. 1 obtains the segment model from the segment modeler 108. The segment estimator 110 also obtains measurements of characteristics from the measurement collector 106 for an area that is to be analyzed (e.g., an area for which a consumer segment 102 is to be estimated). In the example of FIG. 1, the segment estimator 110 obtains measurements for those characteristics that are modeled in the segment model (e.g., non-modeled characteristics are irrelevant to the model and need not be collected).

The example segment estimator 110 estimates a consumer segment population 114 (e.g., a population of persons falling within the specified consumer segment 102) for a specified consumer segment by applying the segment model to the second measurements. The result of the estimate is a geographically based set of population estimates or features of the specified consumer segment 102. For example, the segment estimator 110 may generate a table of segments and estimated population describing the probabilit(ies) for the geographic area being evaluated. The example consumer segment population 114 (e.g., a table of segments and estimated population) of FIG. 1 may include discrete estimates for sub-regions of the geographic area. Additionally or alternatively, the consumer segment estimation 114 (e.g., a table of segments and estimated population) may be expressed using one or more functions that may be used to calculate a probability value of a consumer segment for any selected location within the geographic area corresponding to the identifier 104 (e.g., a function that may be visualized in a heat map overlaid on a map of the geographic area).

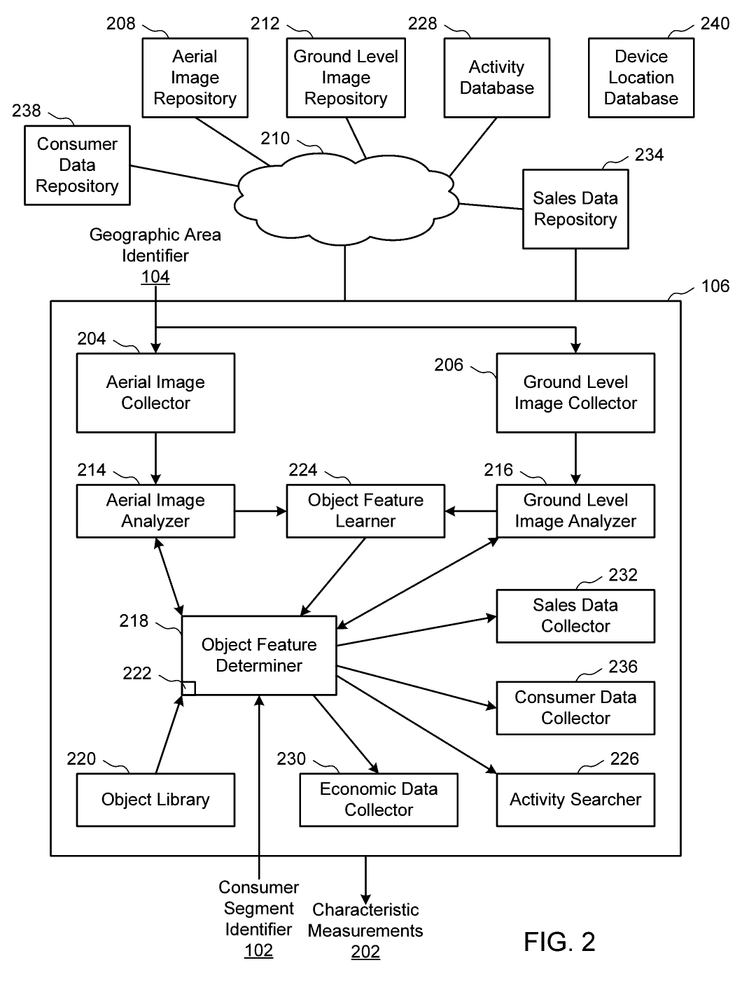

FIG. 2 is a block diagram of an example implementation of the measurement collector 106 of FIG. 1. As mentioned above, the example measurement collector 106 receives an identifier of a consumer segment (e.g., the consumer segment identifier 102 of FIG. 1) and an indication of a geographic area (e.g., the geographic area identifier 104 of FIG. 1). The example measurement collector 106 of FIG. 2 outputs characteristic measurements 202 (e.g., to the segment modeler 108 and/or to the segment estimator 110 of FIG. 1).

The example measurement collector 106 of FIG. 1 includes an aerial image collector 204 and a ground level image collector 206. As explained in more detail below, the example aerial image collector 204 collects aerial image(s) of the geographic area specified by the geographic area identifier 104 and/or collects ground level image(s) taken within the specified geographic area. As used herein, the term “images” may refer to still images and/or images extracted from video.

From the geographic area identifier 104, the example aerial image collector 204 identifies the location of the specified geographic area and requests an aerial image of the specified geographic area from an aerial image repository 208. For example, the aerial image collector 204 may interpret a text description of the geographic area identifier 104 (e.g., a 5-digit zip code, a name of a municipality, country, or state, etc.) to a coordinate system (e.g., a set of GPS coordinates indicating a boundary or perimeter of an area) or other system used by the aerial image repository 208 to identify aerial images.

The example aerial image repository 208 of FIG. 2 provides aerial and/or satellite image(s) of specified geographic areas (e.g., the geographic area 104 and/or surrounding areas) to a requester that identifies those areas (e.g., via a network 210 such as the Internet). The example aerial images obtained by the aerial image collector 204 may include aerially generated images (e.g., images captured from an aircraft such as airplanes, helicopters, and/or drones, which may be operated by governments, commercial organizations, individuals, etc.), satellite-generated images (e.g., images captured from a satellite), and/or drone images (e.g., images captured using drone aircraft by governments, commercial organizations, individuals, etc.). The images may have any of multiple sizes and/or resolutions (e.g., images captured from various heights over the geographic areas). Example satellite and/or aerial image repositories that may be employed to implement the example aerial image repository 208 of FIG. 1 are available from DigitalGlobe®, GeoEye®, RapidEye, Spot Image®, and/or the U.S. National Aerial Photography Program (NAPP). The example aerial image repository 208 of the illustrated example may additionally or alternatively include geographic data such as digital map representations, source(s) of population information, building and/or other man-made object information, and/or external source(s) for parks, road classification, bodies of water, etc.

The geographic area corresponding to the geographic area identifier 104 may be represented by one or more separate, individual images provided by the aerial image repository 208. The division of images may be based on the resolution of the images (e.g., whether the image at a particular level of zoom has sufficient detail to identify contextual features with sufficient accuracy).

The example aerial image collector 204 determines the scale and the relationships between the received image(s) (e.g., for use in determining distance). For example, the aerial image collector 204 may determine the pixel area and/or the scale from metadata associated with the image.

From the geographic area identifier 104, the ground level image collector 206 obtains images from a ground level image repository 212. In some examples, the ground level image collector 206 queries the ground level image repository 212 using keywords associated with the consumer segment identifier 102, keywords associated with the specified geographic area 104, and/or metadata queries determined based on the geographic area identifier 104. For example, the ground level image collector 206 may query the ground level image repository 212 for images taken within a particular time range, having metadata (e.g., location metadata such as Global Positioning System coordinates) that indicates that the images were obtained from within the specified geographic area, using keywords corresponding to the geographic area (e.g., street names, municipality names, landmark names, etc.), and/or images having a subject that is associated with characteristics associated with the consumer segment identifier 102.

The example ground level image repository 212 of FIG. 2 provides ground level image(s) of specified geographic areas (e.g., the geographic area 104 and/or surrounding areas) to a requester that identifies those areas (e.g., via the network 210). The example ground level images obtained by the ground level image collector 206 may include street-level images (e.g., images automatically captured by a street-view camera, such as the Google Street View™ mapping service or other similar mapping services) and/or user-generated images (e.g., images automatically or manually captured by an individual and uploaded to an image hosting service such as the Flickr® photo hosting service, the Google+™ Photos photo sharing service, Photobucket® photo sharing service, and/or any other source of images). While the ground level image repository 212 is shown as a single entity in FIG. 2, the ground level image repository 212 may be implemented using any number of different sources and/or entities.

In an example in which the geographic area identifier 104 corresponds to Schaumburg, Ill., United States, and the consumer segment identifier 102 is “08 Executive Suites” (e.g., Upper-Middle-Class singles and couples, middle-aged, without children, as defined by Nielsen PRIZM®), the example ground level image repository 212 may send one or more queries to the ground level image repository 212 that specifies the location “Schaumburg, Ill., United States,” and/or the equivalent range of GPS coordinates, and includes keywords that are predicted to provide an indication of the presence of the specified consumer segment, such as geographic-related keywords, demographic-related keywords, psychographic-related keywords, benefit-related keywords, behavior-related keywords, and the like. The example ground level image repository 212 returns the results of the quer(ies) to the ground level image collector 206.

The example measurement collector 106 of FIG. 2 further includes an aerial image analyzer 214. The example aerial image analyzer 214 uses computer vision to identify features from the aerial images obtained by the aerial image collector 204. The example aerial image analyzer 214 of FIG. 2 uses computer vision recognition techniques, such as the bag-of-words model for computer vision, to identify features or objects in the aerial images that are associated with the consumer segment identifier 102. For example, if the consumer segment identifier 102 is “08 Executive Suites” (or another consumer segment to which swimming pools are related), the example aerial image analyzer 214 may search for swimming pools and/or appropriately-sized bodies of water in the aerial images. However, the aerial image collector 204 may use other past, present, and/or future computer vision methods, and/or combinations of methods, to measure counts of objects in the aerial images. The use of computer vision to identify the contextual features increases the efficiency, increases the accuracy, and/or reduces the resources required to identify objects related to a consumer segment identifier 102 relative to some other computer vision techniques for object recognition.

In some examples, the aerial image analyzer 214 and/or the ground level image analyzer 216 identify collections of objects that are highly similar in shape, size, color, geographic distribution, and/or other observable attributes. The example aerial image analyzer 214 may identify that the collection of objects is homogenous; that is, that the collection of objects has a high similarity metric. For example, if a collection of houses in an area appears to be highly similar based on size (from aerial and ground level views), facade, and spacing, the example segment modeler 108 may apply objects identified near the collection of similar houses to other collections of houses that are similar to the observed similar collection. That is, while objects may not be identifiable from images of the second collection of houses, the homogeneity of both collections and their similarities with each other may permit the segment modeler 108 to weight the observed objects similarly and/or to impute the presence and/or count of observed objects to the second collection of houses at which the objects were not observed.

Conversely, in some examples, the aerial image analyzer 214 identifies collections of objects that are similar in some aspects but highly diverse in others. For example, a collection of houses that is highly varied may have a low similarity metric, and may not be used to impute characteristics to other areas.

The example measurement collector 106 of FIG. 2 further includes a ground level image analyzer 216. The example ground level image analyzer 216 analyzes ground level images obtained by the ground level image collector 206 to identify objects related to the consumer segment identifier 102. The example ground level image analyzer 216 may search ground level images using computer vision in a manner similar to the aerial image analyzer 214. However, the example ground level image analyzer 216 of FIG. 2 may additionally or alternatively search for different objects or features, use different computer vision techniques, and/or search for the same objects and/or features using the same computer vision techniques but using different object features than the aerial image analyzer 214.

For example, if searching the ground level images for swimming pools, the ground level image analyzer 216 searches for swimming pool features such as that would be observed from a ground level perspective (as opposed to a different shape that would likely be seen from an aerial perspective). The example ground level image analyzer 216 may additionally or alternatively search for swimming pools in ground level images by searching for the presence of geotagged photos of people in swimming pools, above-ground swimming pool structures, pool decks surrounding swimming pools, fences surrounding swimming pools, and/or other aspects that distinguish ground level views of swimming pools from aerial views of swimming pools.

The example aerial image analyzer 214 and the example ground level image analyzer 216 of FIG. 2 access features that are to be searched using an object feature determiner 218. The example object feature determiner 218 receives the consumer segment identifier 102 and accesses an object library 220 to determine object(s) that are associated with the consumer segment identifier 102. The object library 220 also includes descriptions of the objects in the object library 220. The descriptions of the objects enable the aerial image analyzer 214 and the ground level image analyzer 216 to visually analyze images to identify the objects.

The example object feature determiner 218 includes an segment table 222 that defines relationships between consumer segments, objects, activities (e.g., physical activities and/or digital device-based activities), economic data, and/or any other information that is associated with a consumer segment.

For example, the segment table 222 of FIG. 2 associates consumer segments (e.g., the consumer segments that may be input via the consumer segment identifier 102) based on identified characteristics of the consumer segments. For example, the segment table 222 may associated the consumer segment “24 Up-and-Comers” with particular types of housing, particular types of automobiles (and/or a relative lack of automobile ownership or a relatively higher use of ride-sharing), and/or geographic proximity to particular types of points of interest, among others.

When the object feature determiner 218 receives one of the listed consumer segments as the consumer segment identifier 102, the object feature determiner 218 queries the segment table 222 to obtain objects associated with the consumer segment and/or characteristics that are shared with others of the consumer segments in the segment table 222. The example object feature determiner 218 accesses the object library 220 to obtain the descriptions of the related objects. The object feature determiner 218 provides the descriptions to the aerial image analyzer 214 and/or to the ground level image analyzer 216 for use in identifying instances of objects corresponding to the consumer segment identifier 102 and/or the identified related concepts. The example descriptions of objects may be different for different areas. For example, some geographic areas may have more in-ground swimming pools while other areas have more above-ground swimming pools.

In some examples, the object feature determiner 218 sends relevant portions of the descriptions to each of the aerial image analyzer 214 and the ground level image analyzer 216. For example, the object feature determiner 218 may identify and provide descriptions corresponding to overhead perspectives of the objects to be identified to the aerial image analyzer 214. Conversely, the object feature determiner 218 identifies and provides descriptions of ground level perspectives of the objects to be identified to the ground level image analyzer 216. Example descriptions include visual characteristics, such as shapes, colors, sizes, and/or textures of objects and/or sub-components of the objects, combinations of sub-components, and/or spatial arrangements of sub-components. In the example of FIG. 2, a description of an object includes a set of features having corresponding weights. The weight(s) of a feature may be based on the importance of the feature to a particular identification of the object and/or based on a relationship of the feature to other features that may or may not be present. When the aerial image analyzer 214 or the ground level image analyzer 216 identifies an object under consideration as having a particular feature of an identifiable object (e.g., an outline shape of a swimming pool, a color associated with swimming pool water), the aerial image analyzer 214 or the ground level image analyzer 216 increases the likelihood that an object under consideration is the identifiable object (e.g., a swimming pool) based on the weight corresponding to the feature.

The example segment table 222 may be populated and/or updated manually, and/or by machine learning (e.g., by associating concepts such as consumer segments, objects, activities, and/or economic information using relevance-based searching). In some examples, the example object feature determiner 218 updates the segment table 222 by searching word association services based on a received consumer segment identifier 102.

The example object library 220 and/or the example segment table 222 of FIG. 2 may be populated by, for example, persons with knowledge of the relationships between a consumer segment identifier 102 and other objects, activities, and/or economic information, and/or by persons who manually review a set of test images to determine characteristics corresponding to the consumer segment identifier 102. For example, the consumer segments used in the PRIZM system have well-defined demographic characteristics and purchasing preferences that form a foundation for relationships between segments and objects, activities, and/or economic information in the segment table 222. In some other examples, the object feature determiner 218 populates and/or updates the object library 220 and/or the segment table 222 through trial-and-error and/or machine learning based on feedback associated with detected contextual features.

Any of the example aerial image collector 204, the ground level image collector 206, the aerial image analyzer 214, the ground level image analyzer 216, the object feature learner 224, the activity searcher 226, the economic data collector 230, the sales data collector 232, and/or the consumer data collector 236 may be supplemented by data captured via manual data capture. For example, data provided by the ground level image analyzer 216 may be supplemented by data obtained by a person at a location taking data on the presence of objects (e.g., counting cars). Additionally or alternatively, data included in any of the activity database 228, the sales data repository 234, and/or the consumer data repository 238 may be supplemented by data collected via manual data collection, such as data obtained by manually surveying people and/or businesses for activity, sales, and/or economic data.

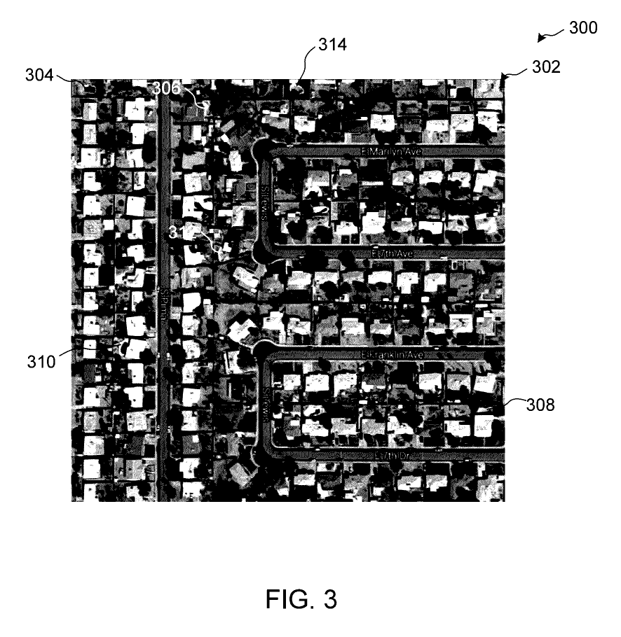

FIG. 3 is an example aerial image 300 that may be measured by the example measurement collector 106 of FIGS. 1 and/or 2 to measure a characteristic of a geographic area 302. The example aerial image collector 204 of FIG. 2 obtains the aerial image 300 of FIG. 3 from the aerial image repository 208.

Using the descriptions provided by the object library 220 via the object feature determiner 218, the example aerial image analyzer 214 analyzes the aerial image 300 images to identify objects related to the consumer segment identifier 102. Using the example consumer segment identifier 102 of “15 Pools & Patios” and a related object of “swimming pool” in the example of FIG. 3, the example aerial image analyzer 214 of FIG. 2 identifies, using computer vision, counts of swimming pools 304, 306, 308, 310, 312, 314 in the aerial image 300. For example, the aerial image analyzer 214 of FIG. 2 may use polygon detection to identify typical shapes of swimming pools, color recognition to identify colors that correspond to swimming pools, and/or an object size threshold to exclude natural bodies of water and/or larger public swimming pools (e.g., municipal swimming pools).

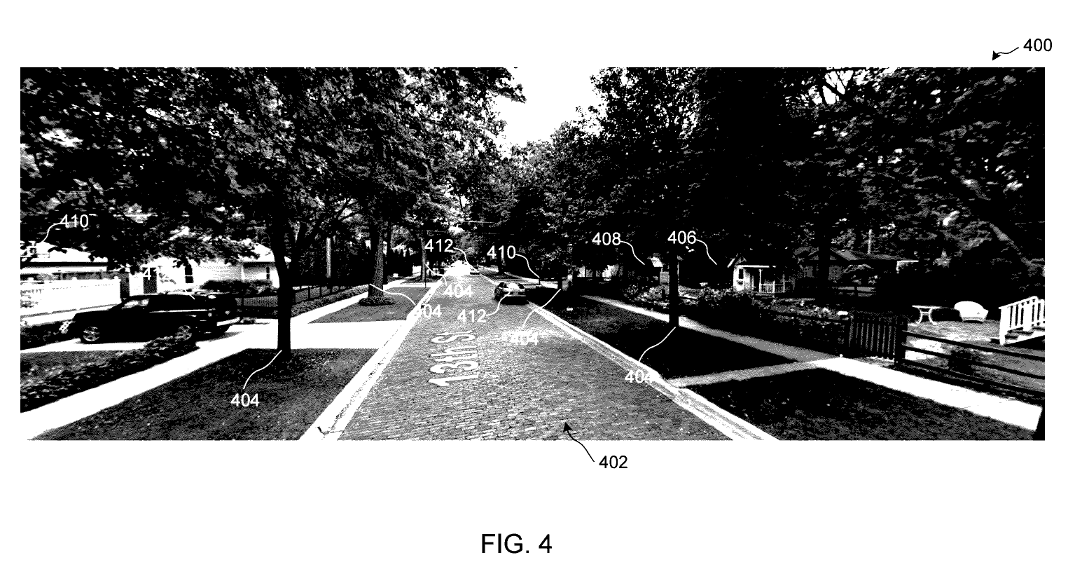

Similarly, the example ground level image analyzer 216 of FIG. 2 may count residential structures (e.g., houses, townhomes, multi-unit apartment buildings, etc.) and/or residential structure types (e.g., single-family homes, townhomes, 2-flats, 3-flats, bungalows, low-rise multi-unit, mid-rise multi-unit, high-rise multi-unit, colonial-style houses, victorian-style houses, etc.) from ground level images. FIG. 4 is an example ground level image 400 that may be measured by the example measurement collector 106 of FIGS. 1 and/or 2 to measure a characteristic of a geographic area. In the example of FIG. 4, the ground level image analyzer 216 identifies a street 402, trees 404 lining the street 402 at similar distances (e.g., a tree-lined street), a trampoline 406, a children's play gym 408, a portable basketball hoop 410, and cars 412. While the example objects are discussed, other objects in the image may also be identified.

The ground level image analyzer 216 uses similar techniques as the aerial image analyzer 214 but uses different descriptions of objects that account for the different perspectives between aerial and ground level images. For example, while the aerial image analyzer 214 uses roof shapes and/or colors for recognition and/or classifications of structures, the ground level image analyzer 216 may use other colors, other shapes, other textures, and/or other features (e.g., windows, doors, patios, etc.) to identify structures. The different descriptions of an object are stored in the object library 220, with metadata relating the descriptions to respective ones of the perspectives.

In the example of FIG. 4, the ground level image 400 is one of a series of street level images taken in succession by a street view imaging service. As a result, multiple views of the street 402, the trees 404, the trampoline 406, the children's play gym 408, the portable basketball hoop 410, and/or the car(s) 412 may be available in images taken adjacent to the location at which the image 400 was taken. In response to identifying the street 402, the trees 404, the trampoline 406, the children's play gym 408, the portable basketball hoop 410, and/or the car(s) 412 (or an object that may be a street, a tree, a trampoline, a children's play gym, a portable basketball hoop, and/or a car) in the image 400, the example ground level image analyzer 216 requests the ground level image collector 206 to obtain images adjacent to the image 400 (e.g., images that are likely to provide different perspectives of the potential objects). The example ground level image analyzer 216 may then analyze the adjacent images obtained from the ground level image repository 212 via the ground level image collector 206 to confirm or eliminate the identification of the street 402, the trees 404, the trampoline 406, the children's play gym 408, the portable basketball hoop 410, and/or the car(s) 412 in the image 400.

In some examples, the ground level image analyzer 216 analyzes ground level images of locations that correspond to objects identified by the aerial image analyzer 214. For example, if the aerial image analyzer 214 identifies an object from an aerial image of a first location, the ground level image collector 206 obtains one or more images corresponding to the first location. The example ground level image analyzer 216 analyzes the one or more images to identify additional characteristic(s) of the identified object and/or to identify other objects related to the object identified by the aerial image analyzer 214. In some examples, the ground view image(s) and aerial view image(s) establish a correlation between objects identified in the images obtained from the different view(s). The correlation(s) can be provided to the segment modeler 108 of FIG. 1 to provide a basis for modeling segment classification.

Returning to FIG. 2, the example measurement collector 106 further includes an object feature learner 224 that receives identifications of objects from the aerial image analyzer 214 and/or the ground level image analyzer 216, identifies feature anomalies (e.g., anomalies between a description of an object and the observed characteristics of instances of the object), and/or confirms consistencies between the characteristics and the descriptions of objects. When the object feature learner 224 identifies a consistency between a description that is provided to the aerial image analyzer 214 and/or the ground level image analyzer 216 from the object library 220 (e.g., via the object feature determiner 218) and the object(s) in the analyzed image(s), the object feature learner 224 may increase a weight applied to the feature for the purposes of recognizing the corresponding object.

Conversely, when the object feature learner 224 identifies an anomaly between the description of an object (e.g., from the object library 220) and a characteristic of the object as identified by the aerial image analyzer 214 and/or the ground level image analyzer 216 (e.g., identified in spite of the anomaly, based on a sufficient number and/or combination of weights of other characteristics of the identified object from the description), the example object feature learner 224 may decrease the weight of the characteristic in the description and/or flag the characteristic for review by an administrator of the measurement collector 106. For example, the administrator may decide to fork the object in the object library 220 into multiple versions of the object, where the versions having some same or similar characteristics and some different characteristics in the respective descriptions. For example, the object type “house” may be forked into townhomes, 2-flats, 3-flats, bungalows, low-rise multi-unit, mid-rise multi-unit, high-rise multi-unit, colonial-style houses, Victorian-style houses, and/or others.

The example aerial image analyzer 214 and/or the ground level image analyzer 216 output counts of the identified objects. The counts of objects may be sorted by type of object. In the example of FIG. 2, the aerial image analyzer 214 and/or the ground level image analyzer 216 further report locations (e.g., GPS coordinates) at which the objects are identified. The example aerial image analyzer 214 may identify the locations of the objects based on the location within the aerial image where the object is found and the locations of the edges of the aerial image. The location of the edges of the aerial image may be defined in metadata of the image and/or otherwise provided by the aerial image repository 208. The example ground level image analyzer 216 may estimate the location of an identified object using location metadata of the image in which the object is recognized.

In addition to searching images of the geographic area, the example measurement collector 106 measures activities associated with the consumer segment identifier 102 in the geographic area using an activity searcher 226. The example activity searcher 226 of FIG. 2 measures the presence, quantity, and/or popularity of activities that are associated with the consumer segment identifier 102. For example, the segment table 222 of FIG. 2 associates objects such as the consumer segment identifier 102 with activities such as public and/or commercial services, events, associations, and/or any other type of activity. The example object feature determiner 218 provides activity types to the activity searcher 226 based on the consumer segment identifier 102 and the segment table 222.

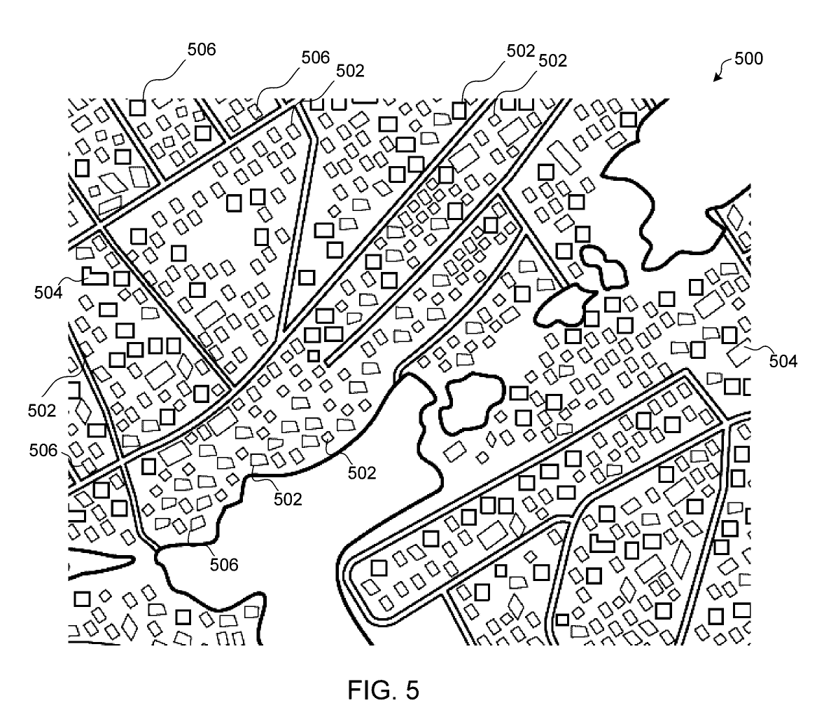

FIG. 5 shows an example geographic area 500 that may be searched by the example measurement collector 106 of FIGS. 1 and/or 2 to measure activities related to a specified consumer segment (e.g., the consumer segment corresponding to the consumer segment identifier 102 of FIGS. 1 and/or 2) as a characteristic of the geographic area 500.

The example activity searcher 226 searches (e.g., sends queries to) an activity database 228 based on the activities from the object feature determiner 218 and the geographic area specified by the geographic area identifier 104. The example activity database 228 may be one or more public and/or proprietary databases relating activities to geographic areas. For example, the activity database 228 may include a commercial database describing the locations of various organizations and/or services, such as mapping services provided by Google Maps™, Foursquare®, TripAdvisor®, and/or any other similar services. In some examples, the activity database 228 includes activity data obtained from surveys and/or ground truth activity information collected via physical sampling or surveying. In such examples, the surveys and/or ground truth may be limited to reduce sampling costs associated with collecting the survey and/or ground truth data.

In the example of FIG. 5, in which the consumer segment identifier 102 is “39 Domestic Duos,” the activity searcher 226 may search mapping services in the activity database 228 for services such as social clubs, nightclubs, casual-dining restaurants, midscale department stores, travel services, and/or other associated services in or within a threshold distance of the identified geographic area 500. The example activity searcher 226 identifies casual dining restaurants 502, midscale department stores 504, and social clubs 506 in the example geographic area 500 based on one or more queries to the activity database 228.

In some examples, the activity database 228 includes location-based interest group databases, such as Meetup® or similar services. Using the example “22 Young Influentials” consumer segment, the example activity searcher 226 may search the activity database 228 for sports league groups (e.g., general sporting or sport-specific groups), exercise groups, foodie groups, technology-interest groups, and/or any other related groups in or within a threshold distance of the identified geographic area 104.

In some examples, the activity database 228 includes publicly accessible event calendars. Using the example “22 Young Influentials” consumer segment, the example activity searcher 226 may search the activity database 228 for public and/or private events related to recreational sports, technology, dining, and/or any other events associated with the consumer segment in or within a threshold distance of the identified geographic area 104. The example activity searcher 226 outputs the identification of the activity and, in some examples, the location of the activity. An example activity location may be the location of a service provider (e.g., a street address or GPS coordinates of a building) identified by the activity searcher 226.

Returning to FIG. 2, the example measurement collector 106 further includes an economic data collector 230. The example economic data collector 230 of FIG. 2 collects data representative of the economic capacity of the geographic area identified by the geographic area identifier 104 (e.g., general economic capacity and/or purchasing ability, such as disposable income). The economic data collector 230 may use objects identified by the aerial image analyzer 214 and/or the ground level image analyzer 216, and/or may obtain data unrelated to identified objects. For example, the economic data collector 230 may make inferences about the geographic area based on features in the aerial images and/or the ground level images, such as average and/or median car value, residential structure types and/or densities, and/or any other observable features. Additionally or alternatively, the economic data collector 230 may obtain information from web services, such as median home values obtained from real estate listing sites, price information for good types based on merchants identified in the geographic area using a map service or directory, car dealer information and associated retail prices of cars in the geographic area, and/or any other non-image based information.

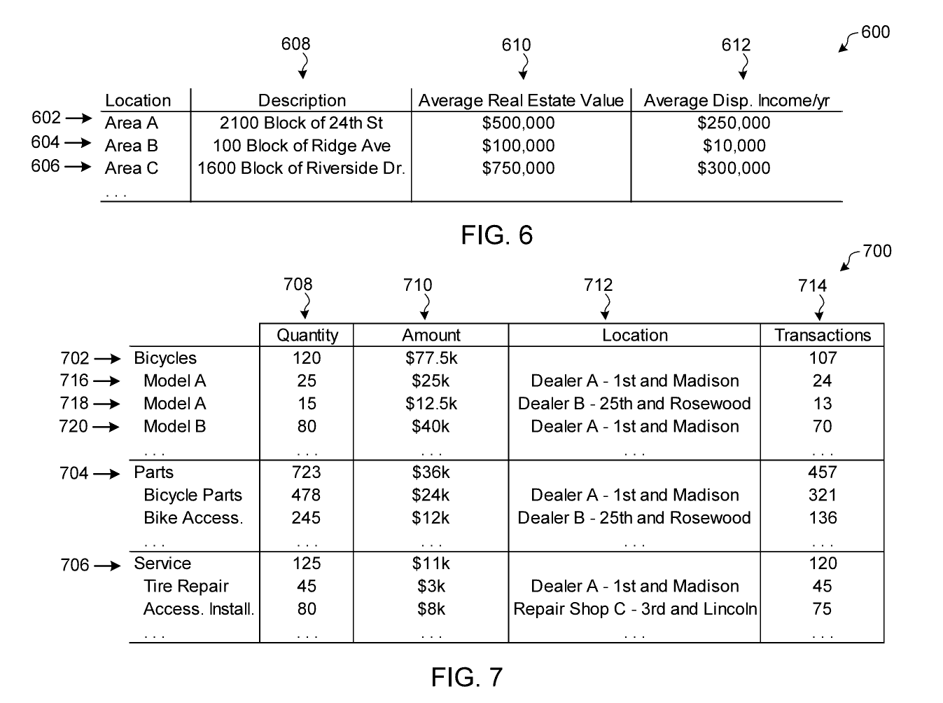

FIG. 6 is a table 600 including example economic information that may be collected and analyzed by the example measurement collector 106 of FIGS. 1 and/or 2 to measure economic capacity as a characteristic of a geographic area. The example table 600 includes locations 602, 604, 606 that are sub-regions of the geographic area (e.g., the geographic area identified by the geographic area identifier 104 of FIGS. 1 and/or 2).

Each of the example locations 602-606 in FIG. 6 is provided with a description of the locations 602-606. Example descriptions include keyword or plain language descriptions (e.g., the 1000 block of 1^{st} Street; the block bounded by 1^{st} Street, 2^{nd} Street, Madison Avenue, and Washington Boulevard; the Highland Park neighborhood; the 5^{th} Ward; the 7^{th} District; etc.), using GPS coordinates to define a boundary and/or key points of the boundary (e.g., two points of a rectangle), and/or any other method of describing the locations 602-606.

The example locations 602-606 in the table 600 may represent an area of any size within the geographic area 104, and/or may be selected by combining (e.g., averaging, summing, etc.) the economic data from a number of smaller sub-regions into a larger sub-region. For example, as the economic data collector 230 collects economic data such as estimated real estate values 608 for commercial and/or residential real estate, the economic data collector 230 may collapse the data for a block of real properties into an average real estate value (e.g., per square foot, per lot of X size, etc.) representative of the entire block.

In some examples, the economic data collector 230 calculates estimated residential building values (e.g., home values) from observable features (e.g., the features described above) in the aerial image(s), the ground level image(s), and/or supplemental data. For example, the economic data collector 230 may estimate home values in the geographic area 104 based on building densities, building textures, nearby building types, vehicle traffic, distances to designated locations, and/or landmarks. In the example of FIG. 2, the object feature determiner 218 provides descriptions of economic-related features to the aerial image analyzer 214 and/or the ground level image analyzer 216, obtains measurements of features in the aerial images and/or ground level images from the aerial image analyzer 214 and/or the ground level image analyzer 216, and provides the resulting measurements to the economic data collector 230. Example features that may indicate higher home values in some locations include: shorter distances to parks, bodies of water (e.g., lakes, rivers, oceans), and/or transportation features; higher elevations; desirable features on or near the property (e.g., waterfront property); the presence of swimming pools; higher concentrations of parked cars (e.g., on the sides of roads, off the roads, etc.); and/or roofs of a particular color. The example table 600 of FIG. 6 includes estimated average real estate values 610 for the example locations 602-606.

In some examples, the economic data collector 230 accesses online data sources, such as online real estate sources (e.g., www.zillow.com, etc.) and/or public records (e.g., taxation records, public assessment records, public real estate sales records, etc.) to estimate home values. In some examples, features observable from aerial and/or ground level image may indicate higher or lower home values. Additionally or alternatively, the example economic data collector 230 of FIG. 2 may combine the visually observed information described above with public real estate records (e.g., sales records, taxation records) to estimate the residential building values.

The example economic data collector 230 outputs the economic data and/or inferences drawn from the economic data. The example economic data collector 230 may group economic data that are obtained from a particular location or area to be specific to that location or area. In some examples, the economic data collector 230 outputs groups of economic characteristics (e.g., economic data) that respectively correspond to sub-regions of the geographic area, such as when a group of economic characteristics indicate a same or similar economic capacity for the corresponding sub-region. The example table 600 of FIG. 6 includes estimated average disposable income per year 612 determined by the economic data collector 230 for each of the example locations 602-606. The example average disposable income per year 612 of FIG. 6 may be per capita, per unit of area, or any other unit.

Returning to FIG. 2, the example measurement collector 106 includes a sales data collector 232. The example sales data collector 232 of FIG. 2 accesses a sales data repository 234 to access information related to sales of products and/or services related to the consumer segment identifier 102 and/or the geographic area identifier 104. Using the segment table 222, the example object feature determiner 218 determines products and/or services for which sales data are relevant to determining a population of the specified consumer segment in the specified geographic area. The example sales data collector 232 searches one or more public and/or proprietary databases for sales data for the identified products and/or services. In some examples, the sales data repository 234 includes sales data obtained from surveys and/or ground truth sales information collected via physical sampling or surveying. In such examples, the surveys and/or ground truth may be limited to reduce sampling costs associated with collecting the survey and/or ground truth data.

For example, the sales data collector 232 accesses sales information from one or more partner entities, such as manufacturers, sellers, and/or providers within the geographic area 104 of goods and/or services identified as being related to the consumer segment identifier 102. In the example of the “23 Greenbelt Sports” consumer segment identifier 102, the example sales data collector 232 may query the sales data repository 234 for sales of outdoor sporting equipment such as for skiing, canoeing, backpacking, boating, and/or mountain biking, and/or replacement components for such products, from corresponding dealers from which sales information is available. Additionally or alternatively, the example sales data collector 232 may query the sales data repository 234 for repair, delivery, and/or storage service sales data.

The example sales data collector 232 outputs the sales data in association with locations where the corresponding sales occurred. For example, if a car dealership in the geographic area 104 provides car sales information, the example sales data collector 232 associates the location of the car dealership with the car sales information.

In some examples, the sales data collector 232 de-couples sales made at a point of purchase (e.g., a retail store or dealership) and/or via an electronic platform from a location associated with the point of purchase and/or electronic platform. This de-coupling may be performed when, for example, the home location of the purchaser can be identified as within the geographic area 104, but the location of purchase is outside the geographic area 104. In this manner, the example sales data collector 232 enhances the accuracy of sales that are attributable to the geographic area 104.

In some examples, the sales data collector 232 is used to measure sales data when developing a model for a consumer segment corresponding to the consumer segment identifier 102, but is not used to measure sales data when applying the model to a geographic area for which a population of a consumer segment is to be predicted.

FIG. 7 is a table 700 of example sales information that may be collected and analyzed by the example measurement collector 106 of FIGS. 1 and/or 2 to measure sales information related to a specified consumer segment as a characteristic of a geographic area. The example table 700 of FIG. 7 includes sales information 702 for objects in the consumer segment identifier 102 of FIGS. 1 and/or 2, and sales information 704, 706 for products and/or services related to the consumer segment identifier 102 (e.g., as determined using the segment table 222 of FIG. 2). In the example of FIG. 7, the consumer segment identifier 102 is “23 Greenbelt Sports” and related products and/or services include bicycles 702, parts 704 and service 706.

The sales information in the example table 700 of FIG. 7 includes a sales quantity 708 (e.g., a number of items sold), a sales amount 710 (e.g., in currency such as U.S. dollars), a sales location 712 (e.g., GPS coordinates or another location designation, such as an online or Internet sale), and a number of transactions 714 (e.g., transactions in which the sales quantity 708 and/or the sales amount 710 occurred) for each of the sales information 702-706.

Each of the products and/or services for which the sales information 702-706 is present in FIG. 7 includes sub-types of those products and/or services. For example, bicycles 702 are split into Model A and Model B, where the sales information 702 includes sales information 716, 718 for the same bicycle model (Model A) from multiple sources and sales information 720 for a second bicycle model (Model B).

Returning to FIG. 2, the example measurement collector 106 further includes a consumer data collector 236 that collects consumer data based on the geographic area identifier 104. Example consumer data includes demographic data such as age, gender, race, household income, number of children, education, and/or any other demographic information.

The example consumer data collector 236 also collects market segmentation data based on the geographic area 104. Example market segmentation data includes the prevalence of defined market segments (e.g., PRIZM market segments defined by The Nielsen Company, or any other defined market segments), behavioral information (e.g., products used by people within the geographic area 104, price sensitivity, brand loyalty, and/or desired benefits of purchases), and/or psychographic information (e.g., information about values, attitudes and lifestyles of people in the geographic area 104). When information is being collected to determine the prevalence of defined market segments, the example consumer data collector 236 omits collection of defined market segments. In examples in which market segment information is to be updated, the example consumer data collector 236 may collect available market segment information (which may be outdated). In some examples, the consumer data collector 236 collects data that partially overlaps with the activity data collected by the activity searcher 226.

The example consumer data collector 236 collects the demographic data and/or market segmentation data (if any) from a consumer data repository 238. The example consumer data repository 238 may obtain consumer data from official sources (e.g., official and/or governmental population census measurements), commercial sources (e.g., consumer measurement services, such as services provided by The Nielsen Company), surveys of people located within the geographic area (e.g., Internet surveys, in-person surveys, telephone surveys, etc.), and/or by obtaining consumer data from partner entities that collect such data during the course of business (e.g., online social networks, credit agencies, and/or any other entities). The sources of demographic data and/or market segmentation data discussed above are merely examples, and any other sources may be used.

Additionally or alternatively, the example consumer data collector 236 of FIG. 2 collects electronic device data for consumer devices, such as location data from GPS devices, mobile phones, and/or any other devices for which location data may be measured and/or deduced. The example consumer data collector 236 may request and/or receive the location data from a device location database 240. The example device location database 240 stores from available sources of location information. For example, the device location database 240 may store location data obtained based on IP addresses, connections to wireless access points for which a location is known, self-reporting by devices that can measure their own location, triangulation performed by wireless communications service providers (e.g., using wireless network base stations), and/or any other location measurement techniques. In the example of FIG. 2, the device location database 240 and/or the consumer data collector 236 may have partnerships with one or more services capable of obtaining location information for devices within the geographic area 104. Examples of such services may include mobile communications network providers (e.g., Verizon Wireless®, AT&T®, Sprint®, T-Mobile®, etc. in the United States, or other providers for different countries), wireless communications network proprietors (e.g., owners and/or operators of wireless access points that provide wireless network services), web site operators that collect location data via their web sites, and/or any other services.

In some examples, the consumer data collector 236 of FIG. 2 may obtain and use the location data (and/or corresponding timestamps of the location data) to determine the relative usage, visitation, and/or popularity of particular location(s) within the specified geographic area based on a number of occurrences of devices being identified as located at the particular location(s). For example, when the consumer segment identifier 102 is “03 Movers & Shakers,” the example consumer data collector 236 may collect location data that indicates a number of devices and/or occurrences of devices at locations such as high-end retail stores, private golf clubs, and/or upscale restaurants. Additionally or alternatively, the consumer data collector 236 may use the location data to track movement of devices between a location that is correlative or anti-correlative for the consumer segment identifier 102 to one or more sub-regions of the specified geographic area. Using movement data, the example consumer data collector 236 may determine which of the sub-regions have higher and/or lower percentages of people travel to the location.

Additionally or alternatively, the example consumer data collector 236 may collect location data that is anti-correlative with the consumer segment identifier 102. For example, the consumer data collector 236 may collect location data corresponding to public transportation routes (e.g., to estimate a number of people in the specified geographic area who use public transportation to travel rather than personal vehicles) and/or to public highway routes (e.g., to estimate the number of people in the specified geographic area who drive at specified times of day).

The example measurement collector 106 of FIG. 2 outputs the characteristic measurements 202 measured by the aerial image analyzer 214, the example ground level image analyzer 216, the example activity searcher 226, the example economic data collector 230, and/or the example sales data collector 232. For example, the aerial image analyzer 214 and/or the ground level image analyzer 216 output count(s) of objects related to the consumer segment identifier 102 counted from collected images of the specified geographic area. The counts of objects may be sorted by the types of objects. The example activity searcher 226 outputs count(s) of activities related to the specified geographic area and the geographic area identifier 104. The example economic data collector 230 outputs one or more characterizations or estimates of the economic capacity of the specified geographic area. The characterizations or estimates may be determined for sub-regions of the specified geographic area. The example sales data collector 232 outputs sales information for products and/or services related to the consumer segment identifier 102 in the specified geographic area 104.

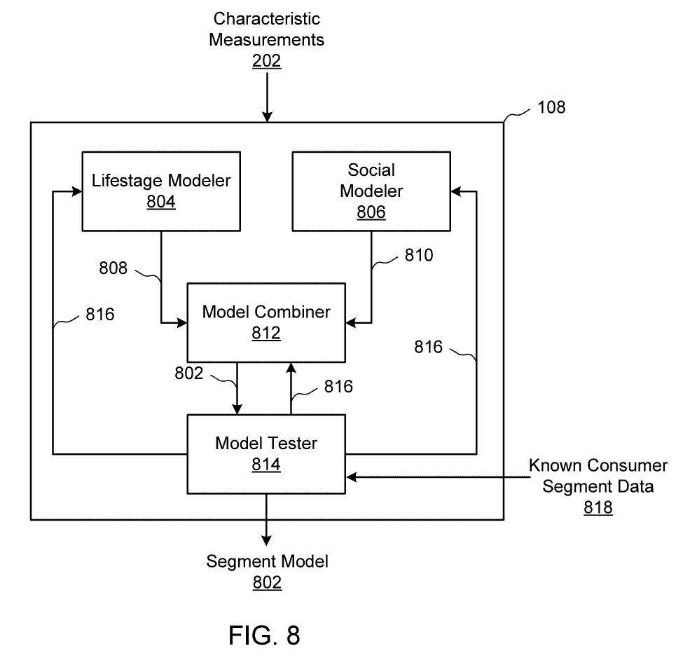

FIG. 8 is a block diagram of an example implementation of the example segment modeler 108 of FIG. 2. The example segment modeler 108 of FIG. 8 receives characteristic measurements 202 from the example measurement collector 106 of FIGS. 1 and 2 and generates a segment model 802 describing a relationship between the characteristic measurements 202 and a population of a consumer segment that corresponds to the consumer segment identifier 102, for the geographic area corresponding to the geographic area identifier 104. The example segment modeler 108 of FIG. 8 includes a lifestage 804 and a social modeler 806.

The example lifestage modeler 804 generates a lifestage model 808 based on lifestage information corresponding to known consumer segments. In the example of FIG. 8, the relationship is expressed as a geographic relationship between the characteristic measurements 202 and the lifestage (e.g., PRIZM lifestage) associated with the consumer segment identifier 102 (e.g., a function of distance). For example, the lifestage model 808 describes the number of people falling within the corresponding lifestage (e.g., combination of affluence, age, and presence of children) of the consumer segment identifier 102 as a function of distance from one or more points of interest in the geographic area corresponding to the geographic area identifier 104. For example, higher (or lower) numbers of people belonging to a specific lifestage may be found closer to a point of interest, farther from a point of interest, or within a designated range of distances from a point of interest (e.g., close, but not too close). In the example of FIG. 8, the lifestage modeler 804 generates the lifestage model 808 to have a location-based component that enables application of the lifestage model 808 to different regions of a geographic area based on the locations associated with measured characteristics in the geographic area.

The example lifestage modeler 804 determines the affluence, the age, and/or the presence of children based on, for example, objects identified by the aerial image analyzer 214 and/or the ground level image analyzer 216, activities and/or services located in the geographic area 104, and/or sales information obtained from the geographic area. For example, the affluence of the area may be determined by sales information for different types of retail locations (e.g., upscale retail, midscale retail, bargain retail). Similarly, children information can be obtained by identifying and/or counting child-related objects such as basketball hoops, outdoor play gyms and/or other toys, and/or by determining sales information for child-related merchants in the geographic area.

The example lifestage modeler 804 performs regression analysis to estimate the relationships between identified objects (e.g., objects related to the consumer segment identifier 102), sales information (e.g., sales of goods and/or services, and/or sales for retail locations) at different levels of affluence and/or for child-related items, activities (e.g., activities related to the consumer segment identifier 102) and a population for the specified consumer segment. In some examples, the lifestage modeler 804 generates the lifestage model 808 as function of distance from identified object locations (and the types of those objects), activity locations (and the types of those activities), and/or sales locations (and the identifications and quantities of the products and/or services sold). Additionally or alternatively, the lifestage modeler 804 generates the lifestage model 808 as function of densities of identified objects, activities, and/or sales in an area. Thus, a location (e.g., a point) within the specified geographic area, as well as locations of other identified objects, the types of those identified objects, locations of activities, and the types of those activities may then be input into the lifestage model 808 to calculate total numbers and/or locations of persons corresponding to the consumer segment identifier 102.

In some examples, presences and/or counts of identified objects and/or activities are weighted more heavily than locations of the objects and/or activities. For example, certain sales, objects, and/or activities in a geographic area may be weighted more highly for determining the relationships in the lifestage model 808 than other sales, objects, and/or activities. This may be due to, for instance, a higher willingness and/or degree of mobility by persons in one level of affluence to travel to make purchases (e.g., at lower cost) than by persons at another level of affluence (e.g., for higher convenience). In some other examples, the presence of children-related objects (e.g., identified from aerial images and/or ground level images) may be weighted more heavily than the lack of identifiable children-related items.

An example relationship that may be generated by the example lifestage modeler 804 is shown below in Equation 1.

$$P = {W}_{i} [ \begin{matrix}{I}_{1} \\ … \\ {I}_{n}\end{matrix} ] * [ \begin{matrix}\frac{1}{{di}_{1}} & … & \frac{1}{{di}_{n}}\end{matrix} ] + {W}_{a} [ \begin{matrix}{A}_{1} \\ … \\ {A}_{m}\end{matrix} ] * [ \begin{matrix}\frac{1}{{da}_{1}} & … & \frac{1}{{da}_{m}}\end{matrix} ] + {W}_{d} [ \begin{matrix}{D}_{1} \\ … \\ {D}_{o}\end{matrix} ] * [ \begin{matrix}\frac{1}{{dd}_{1}} & … & \frac{1}{{dd}_{o}}\end{matrix} ] + {W}_{e} [ \begin{matrix}{E}_{1} \\ … \\ {E}_{m}\end{matrix} ] * [ \begin{matrix}\frac{1}{{de}_{1}} & … & \frac{1}{{de}_{m}}\end{matrix} ] \qquad ( Equation 1 )$$

In Equation 1 above, P is the estimated population of a given location (e.g., a point in the geographic area 104) of persons belonging to the specified consumer segment for which the relationship is generated. The [I] matrix is an n×1 matrix that includes n objects identified by the measurement collector 106 (e.g., via the aerial image analyzer 214 and/or the ground level image analyzer 216), and the respective values of the objects (e.g., values based on how the objects affect the affluence, age, and/or child status of the population with respect to the consumer segment). The [A] matrix is an m×1 matrix that includes m activities identified by the measurement collector 106 (e.g., via the activity searcher 226), and the respective values of the activities (e.g., values based on how the activities affect the affluence, age, and/or child status of the population with respect to the consumer segment). The [D] matrix is an o×1 matrix that includes o sets of consumer data (e.g., demographic data) identified by the measurement collector 106 (e.g., via the consumer data collector 236), and the respective values of the consumer data (e.g., values based on how the consumer data affect the affluence, age, and/or child status of the population with respect to the consumer segment). The [E] matrix is an o×1 matrix that includes o sets of economic data (e.g., sales data, income data, property value data, etc.) identified by the measurement collector 106 (e.g., via the economic data collector 230), and the respective values of the consumer data (e.g., values based on how the economic data affect the affluence, age, and/or child status of the population with respect to the consumer segment). The [1/d] matrices include the inverses of the distances from the given location to each of the objects in [I], the activities in [A], and the consumer data in [D]. For example, di₁ is the distance between the given location and the location at which the object I₁ is found. The W factors are conversion weights and/or dimensional scale factors the respective data types i, a, d, and e that relate the quantities measured in the different units to the respective contributions of the I, A, D and E terms to the population of the segment of interest. The example lifestage modeler 804 determines or infers the W factors from the known segment information using machine learning techniques.

The example lifestage modeler 804 of FIG. 8 identifies the values of the objects in [I], the activities in [A], the consumer data in [D], and/or the economic data in [E] of Equation 1 to determine the relationship. The example lifestage modeler 804 may further determine exponents to be applied to the distances di, dd, da, and/or de functions to account for non-linearities in the relationship, and/or any other modifications to the example Equation 1. While Equation 1 is an example of a relationship, it is not intended to be limiting and any other appropriate relationship may be used.

While the example lifestage modeler 804 is illustrated in FIG. 8 as one modeler to account for identified objects, activities, and/or consumer data, the example lifestage modeler 804 may be implemented using any number of models, sub-models, and/or data layers to, for example, enable easier changes to the relationships between the models, the sub-models, and/or the data layers.

The example social modeler 806 of FIG. 8 obtains the social-related information in the characteristic measurements 202. The example social modeler 806 models the estimated population belonging to a social group (e.g., a combination of urbanization category and affluence) within the specified geographic area as a whole and/or estimated population belonging to a social group within sub-regions of the specified geographic area. For example, the characteristic measurements 202 may indicate that some sub-regions of the geographic area 104 have a first social group and other sub-regions of the geographic area have a second social group. In some examples, the social modeler 806 generates a social model 810 as function of location within the geographic area 104. A location (e.g., a point) within the geographic area 104 may then be input into the social model 810 to calculate an estimated economic capacity.

An example relationship that may be generated by the example social modeler 806 is shown above in Equation 1, substituting S instead of P and using one or more different weight factors W. The weights and/or exponents used by the social modeler 806 may be different than the weights and/or exponents used by the lifestage modeler 804 for the same identified objects, activities, consumer data, and/or economic data. While Equation 1 is an example of a relationship, it is not intended to be limiting and any other appropriate relationship may be used.

While the example social modeler 806 is illustrated in FIG. 8 as one modeler to account for economic data, the example social modeler 806 may be implemented using any number of models, sub-models, and/or data layers to, for example, enable easier changes to the relationships between the models, the sub-models, and/or the data layers.

The example segment modeler 108 of FIG. 8 includes a model combiner 812 to combine the lifestage model 808 and the social model 810 into a segment model 802. The example model combiner 812 applies weights to the lifestage model 808 and/or the social model 810 to weight the models to attempt to fit the segment model 802 to the observed consumer segment population. In some examples, the lifestage model 808 and the social model 810 are generated to have distributions of population among the possible lifestage groups and possible social groups (in the PRIZM® system), and combining the distributions of the lifestage model 808 and the social model 810 includes determining which portions of the distributions should be weighted more heavily. An example combination of the lifestage model 808 and the social model 810 is shown below in Equation 2.

O=W_{P}*P+W_{S}*S (Equation 2)

In Equation 2, W_{P} is a weight applied by the model combiner 812 to the lifestage population P obtained from the lifestage model 808, and W_{S} is a weight applied by the model combiner 812 to the social group population obtained from the social model 810. The example model combiner 812 may select the weights W_{P}, W_{S} based on the consumer segment identifier 102 and the relative importance of lifestage and social group to the population for the specified consumer segment. For example, if the social model 810 has a balance of population that is heavily represented in one of the possible social groups, the example model combiner 812 may weight the lifestage model 808 (W_{P}) more heavily than the social model 810 (W_{P}>W_{S}) to accurately divide the population into the correct segments. In other examples, the model combiner 812 may select the weights based on comparisons of multiple models with multiple known populations. While Equation 2 illustrates a linear relationship, any other type of equation or model may be used as an alternative to a linear relationship to combine the lifestage model 808 and the social model 810.

The example lifestage modeler 804, the example social modeler 806, and/or the example model combiner 812 use one or more machine learning techniques, such as ensemble methods (e.g., using multiple learning techniques or models and combining the outputs of the techniques or models), to update the values of the objects and/or activities in Equations 1 and/or 2, and/or to update the weights W_{P} and/or W_{S} in Equation 2. For example, the lifestage modeler 804, the example social modeler 806, and/or the example model combiner 812 may modify values and/or weights based on observed ground truth.

In some examples, the lifestage modeler 804, the example social modeler 806, and/or the example model combiner 812 may access retail measurement data, such as Nielsen Scantrack data and/or Retail Measurement Services data (e.g., reports of sales information for products) to determine the values for the [I], [A], [D], and/or [E] matrices, and/or the weights W_{P} and/or W_{S}. For example, the lifestage modeler 804, the example social modeler 806, and/or the example model combiner 812 may use the retail measurement data to identify the strengths of correlations between the consumer segment identifier 102 and activities, objects, consumer data, and/or economic information. The strengths of the correlations may then be used to determine the values for the [I], [A], [D], and/or [E] matrices, and/or the weights W_{P} and/or W_{S}.

In some examples, the lifestage modeler 804, the example social modeler 806, and/or the example model combiner 812 may use past measurements of objects, activities, consumer data, and/or economic data, and/or changes in measurements of objects, activities, consumer data, and/or economic data over time, to generate the lifestage model 808, the social model 810, and/or the segment model 802. For example, applying changes in the count(s) and/or distribution(s) of objects, popularit(ies) and/or location(s) of activities, changes in consumer data, and/or changes in economic data may improve the lifestage model 808, the social model 810, and/or the segment model 802 when compared to using only a single set of measurements (e.g., current or most recent measurements).

The model combiner 812 provides the segment model 802 to a model tester 814. The example model tester 814 of FIG. 8 tests the segment model 802 using known consumer segment data 818 (e.g., known economic data, sales data, activity data, and/or object data for a geographic area). The known consumer segment data 818 may be obtained by physically surveying or sampling consumer segment data, economic data, sales data, activity data, and/or object data (e.g., using people performing the surveying and/or sampling). For example, known characteristics of a geographic area may be determined from performing counting, sampling, and/or other procedures to determine the “ground truth.” As used herein, “ground truth” refers to information collected at the location and intended to accurately depict the characteristics of the area. The ground truthing may be performed by, for example, a market survey and/or research service.

If the example model tester 814 identifies more than a threshold error between the segment model 802 and the known consumer segment data 818, the example model tester 814 feeds back error information 816 to the example lifestage modeler 804, the social modeler 806, and/or the model combiner 812. Example error information 816 includes errors at individual locations in a geographic area corresponding to the known segment data 818, and portions of the known segment data 818 considered to contribute to the consumer segment information at that location in the known segment data 818. For example, the model tester 814 may feed back relevant objects, activities, and/or economic data near the location(s) of the error. The lifestage modeler 804, the segment modeler 806, and/or the model combiner 812 adjust the weights W_{P}, W_{C}, [I], [A], [D], and/or [E] applied to the characteristic measurements 202 for generating the lifestage model 808, the social model 810, and/or the segment model 802.

While the example lifestage modeler 804 and the example social modeler 806 use regression analysis, any other analysis method may be used to quantitatively estimate the relationships between the characteristic measurements 202 collected by the measurement collector 106.

Because the known segment data 818 is similar to the information used to generate the segment model 802, the model tester 814 and/or the known segment data 818 may be omitted in cases in which such data are unavailable (e.g., when ground truth is not available for a consumer segment).

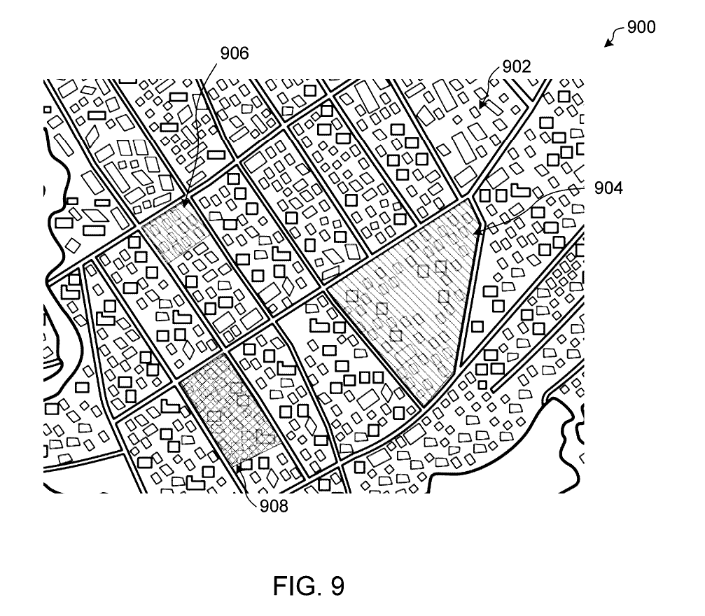

FIG. 9 is a graphical heat map 900 representative of an estimated population of one or more specified consumer segments in a geographic area 902, which is generated by the example segment estimator 110 of FIG. 1 using a segment model 802 generated by the example segment modeler 108 of FIGS. 1 and/or 8. The example heat map 900 of FIG. 9 divides the geographic area 902 into blocks representative of sub-regions of the geographic area 902. The example segment estimator 110 of FIG. 1 generates the heat map 900 by applying the segment model 802 generated by the segment modeler 108 to a set of characteristic measurements obtained from the example measurement collector 106.

The example graphical heat map 900 of FIG. 9 may be generated to provide an easily readable version of segment estimations for viewing. The example heat map 900 of FIG. 9 includes regions 904, 906 in which a population of a first consumer segment is predicted and a region 908 in which a population of a second consumer segment is predicted. The regions 904, 906, 908 may be selected and/or outlined based on, for example, identifying the boundaries of the regions 904-908 in which at least a threshold density of people in the specified consumer segments are predicted. In other examples, the regions 904-908 may be selected to encompass a minimum number of people in the consumer segments.

In some examples, the example graphical heat map 900 includes gradients that illustrate increases and decreases in likely density of a specified consumer segment when moving from one point in the geographic area 902 to another point. For example, the graphical heat map 900 may include lighter shading to signify lower population densities for a consumer segment and darker shading to signify higher population densities for a consumer segment according to the segment model 802.

The example segment modeler 108 is described with respect to FIG. 8 as performing supervised machine learning. That is, the example segment modeler 108 of FIG. 8 generates the lifestage model 808, the social model 810, and/or the segment model 802 to calculate a known outcome (e.g., the known segment data 818). However, the example the lifestage model 808, the social model 810, and/or the segment model 802 may additionally or alternatively be implemented to perform unsupervised machine learning. For example, the lifestage model 808, the social model 810, and/or the segment model 802 may attempt to determine patterns and/or changes in consumer segment populations using the characteristic measurements 202 and without having a known outcome to be achieved. In such examples, the segment model 802 may include one or more relationship(s) between object(s), activit(ies), consumer data, economic data, and/or sales data. Examples of such relationship(s) are relationships that indicate lifestage groups, social groups, and/or consumer segment population.

While the examples above are described with reference to the specific consumer segments used in the Nielsen PRIZM® system, any of the examples may be modified to identify additional or alternative relationships based on collected data that are appropriate for other consumer segmentation models. For example, other consumer segmentation models include the P$YCLE® system and/or the ConneXions® system.

While example manners of implementing the consumer segment determiner 100 of FIG. 1 are illustrated in FIGS. 2 and 8, one or more of the elements, processes and/or devices illustrated in FIGS. 2 and 8 may be combined, divided, re-arranged, omitted, eliminated and/or implemented in any other way. Further, the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example lifestage modeler 804, the example social modeler 806, the example model combiner 812, the example model tester 814 and/or, more generally, the example consumer segment determiner 100 of FIGS. 1, 2, and/or 8 may be implemented by hardware, software, firmware and/or any combination of hardware, software and/or firmware. Thus, for example, any of the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example lifestage modeler 804, the example social modeler 806, the example model combiner 812, the example model tester 814 and/or, more generally, the example consumer segment determiner 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example lifestage modeler 804, the example social modeler 806, the example model combiner 812, and/or the example model tester 814 is/are hereby expressly defined to include a tangible computer readable storage device or storage disk such as a memory, a digital versatile disk (DVD), a compact disk (CD), a Blu-ray disk, etc. storing the software and/or firmware. Further still, the example consumer segment determiner 100 of FIG. 1 may include one or more elements, processes and/or devices in addition to, or instead of, those illustrated in FIGS. 2 and/or 8, and/or may include more than one of any or all of the illustrated elements, processes and devices.

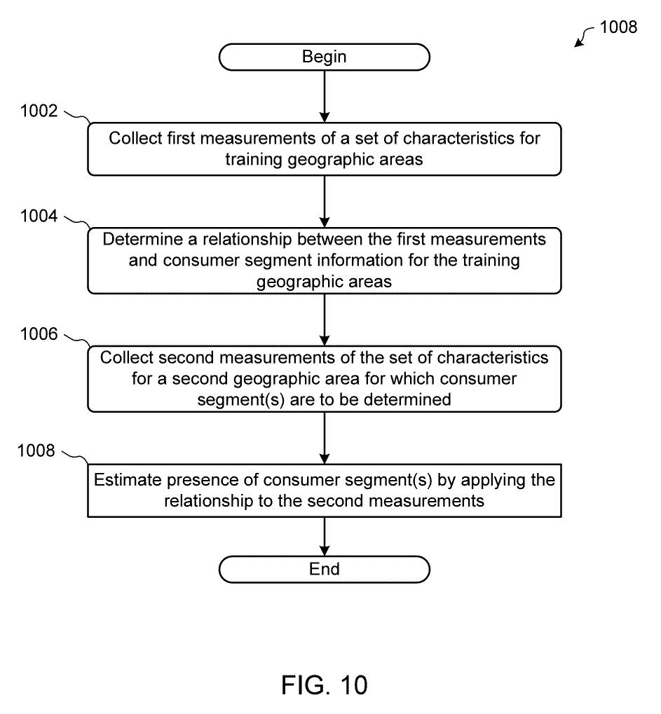

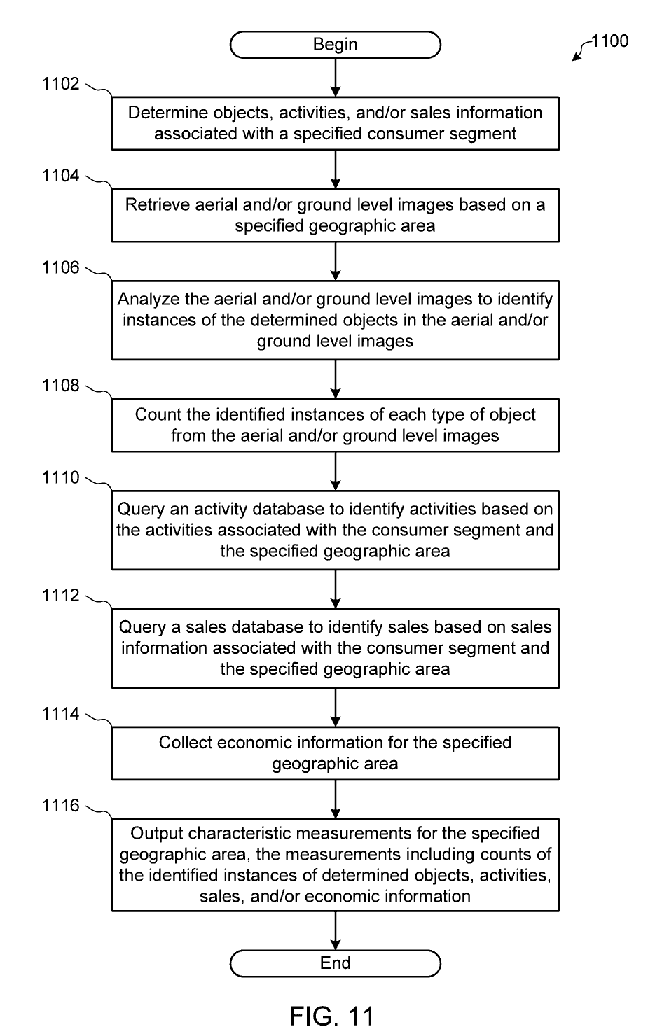

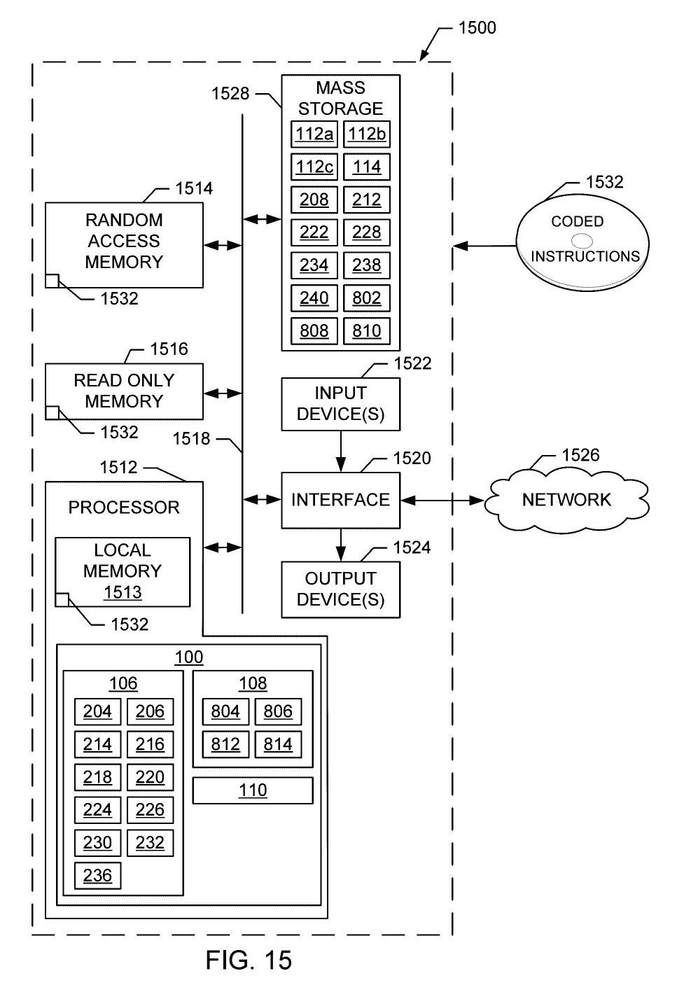

Flowcharts representative of example machine readable instructions for implementing the consumer segment determiner 100 of FIG. 1 are shown in FIGS. 10, 11, and 12. In this example, the machine readable instructions comprise program(s) for execution by a processor such as the processor 1512 shown in the example processor platform 1500 discussed below in connection with FIG. 15. The program(s) may be embodied in software stored on a tangible computer readable storage medium such as a CD-ROM, a floppy disk, a hard drive, a digital versatile disk (DVD), a Blu-ray disk, or a memory associated with the processor 1512, but the entire program(s) and/or parts thereof could alternatively be executed by a device other than the processor 1512 and/or embodied in firmware or dedicated hardware. Further, although the example program(s) are described with reference to the flowcharts illustrated in FIGS. 10, 11, and/or 12, many other methods of implementing the example consumer segment determiner 100 may alternatively be used. For example, the order of execution of the blocks may be changed, and/or some of the blocks described may be changed, eliminated, or combined.

As mentioned above, the example processes of FIGS. 10, 11, and/or 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 10, 11, and/or 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 10 is a flowchart representative of example machine readable instructions 1000 which may be executed to implement the example consumer segment determiner 100 of FIG. 1 to estimate a consumer segment 102 in a geographic area 104.

The example measurement collector 106 of FIG. 1 collects first measurements of a set of characteristics for training geographic areas (block 1002). The first geographic area may be a calibration area or a model-generating area, for which population information for a consumer segment of interest is known. The set of characteristics may include, for example, measurements of the specified consumer segment via sampling, surveys, and/or ground truth measurement. In some examples, the set of characteristics includes measurements of activities related to the consumer segment. In some examples, the set of characteristics includes sales information for products and/or services typically purchased by the consumer segment of interest (e.g., the consumer segment corresponding to the identifier 102) and/or products and/or services avoided by the specified consumer segment. In some examples, the set of characteristics includes economic information for the first geographic area. Example instructions that may be executed to implement block 1002 are disclosed below with reference to FIG. 11.

The example segment modeler 108 of FIG. 1 determines a relationship between a) the first measurements of the set of characteristics and b) consumer segment information for the training geographic areas (block 1004). In some examples, determining the relationship between the first measurements and the consumer segment includes determining relationships between measurement populations and types of housing, types of automobiles, proximity to selected types of points of interest (POIs), and/or other types of characteristics. Some of these items will be evident in street-level photographs, some in POI data, and some from satellite imagery. A combination of relationships between a consumer segment and characteristics may be used to create a signature relationship for the consumer segment. The segment modeler 108 of the illustrated example uses machine learning methods to identify and/or learn such relationships and/or signature relationships between the features that indicate the different segments.

The example measurement collector 106 of FIG. 1 also collects second measurements of the set of characteristics for a second geographic area for which one or more consumer segments are to be determined (block 1006). The example second measurements may be measurements of the same set of characteristics as the first measurements collected in block 1002. Example instructions to implement block 1006 are disclosed below with reference to FIG. 11.

The example segment estimator 110 of FIG. 1 estimates a presence of a consumer segment by applying the relationship to the second measurements (block 1008). For example, the segment estimator 110 may apply the second measurements obtained by the measurement collector 106 to the relationship or model determined by the segment modeler 108. In some examples, the segment estimator 110 estimates the consumer segment(s) (e.g., the probability) as a function of position within the second geographic area. The example segment estimator 110 estimates the consumer segment in units such as population per unit area at a specific location or area in the second geographic area. Upon completion of block 1008, the example instructions 1000 of FIG. 10 end. In some examples, the instructions 1000 iterate to create and/or update a segment model for the same or another consumer segment of interest and/or apply a segment model to another geographic area.

FIG. 11 is a flowchart representative of example machine readable instructions 1100 which may be executed to implement the example consumer segment determiner 100 of FIG. 1 to collect measurements of a set of characteristics for a geographic area. The example instructions 1100 of FIG. 11 may be executed to implement block 1002 and/or block 1006 of FIG. 10 to collect measurements.

The example measurement collector 106 determines objects, activities, and/or sales information associated with a specified consumer segment (e.g., the consumer segment corresponding to the identifier 102) (block 1102). For example, the measurement collector 106 may look up the consumer segment in a table that relates consumer segments to defined characteristics to determine related products, services, and/or activities associated with the consumer segment of interest.

The example measurement collector 106 retrieves aerial and/or ground level images based on the specified consumer segment identifier 102 and a specified geographic area identifier 104 (block 1104). For example, the measurement collector 106 may query an aerial image repository for aerial images of the geographic area corresponding to the identifier 104 and/or query a ground level image repository for ground level images based on the geographic area corresponding to the identifier 104. The specified geographic area may be an area in which a consumer segment of interest is known (e.g., when implementing block 1002 of FIG. 10) and/or an area in which a consumer segment of interest is to be estimated (e.g., when implementing block 1006 of FIG. 10).

The example measurement collector 106 analyzes the aerial and/or ground level images to identify instances of the determined objects in the aerial and/or ground level images (block 1106). For example, the measurement collector 106 uses computer vision and/or descriptions of objects related to the consumer segment of interest (e.g., provided by an object definition library) to identify the presence of objects in the aerial and/or ground level images.

The example measurement collector 106 counts the identified instances of each type of object identified from the aerial and/or ground level images (block 1108). As an example, consider the example consumer segment of “millennials.” The measurement collector 106 of such an example counts the number of “coupe” objects (and/or the number of “minivan” objects) identified in the aerial and/or ground level images, the number of “coupe” objects identified in the aerial and/or ground level images, and so on for each type of object associated with the “millennial” consumer segment.

The example measurement collector 106 queries an activity database to identify activities based on the activities associated with the consumer segment of interest and the specified geographic area of interest (block 1110). For example, the measurement collector 106 may query the activity database to identify services, groups, events, and/or other activity types associated with the consumer segment corresponding to the identifier 102 that are within and/or near the geographic area corresponding to the identifier 104.

The example measurement collector 106 queries a sales database to identify sales based on sales information associated with the consumer segment of interest and the specified geographic area of interest (block 1112). For example, the measurement collector 106 may obtain sales information for products and/or services associated with the consumer segment and/or products and/or services related to the consumer segment. The example measurement collector 106 also collects location information corresponding to the collected sales information, such as locations where sales occurred.

The example measurement collector 106 collects economic information for the specified geographic area (block 1114). For example, the measurement collector 106 collects economic information such as real estate values, individual incomes, local commercial and/or retail characteristics, and/or any other information indicating the economic capacity of the geographic area (and/or sub-regions of the geographic area) to purchase products and/or services corresponding to the consumer segment of interest.

The example measurement collector 106 outputs characteristic measurements for the specified geographic area (block 1116). The example characteristic measurements include counts of the identified instances of determined objects, activities, sales, and/or economic information. The measurement collector 106 provides the characteristic measurements to the segment modeler 108 and/or the segment estimator 110. Upon completion of block 1116, the example instructions 1100 of FIG. 11 end and return control to a calling function, such as block 1002 or block 1006 of FIG. 10.

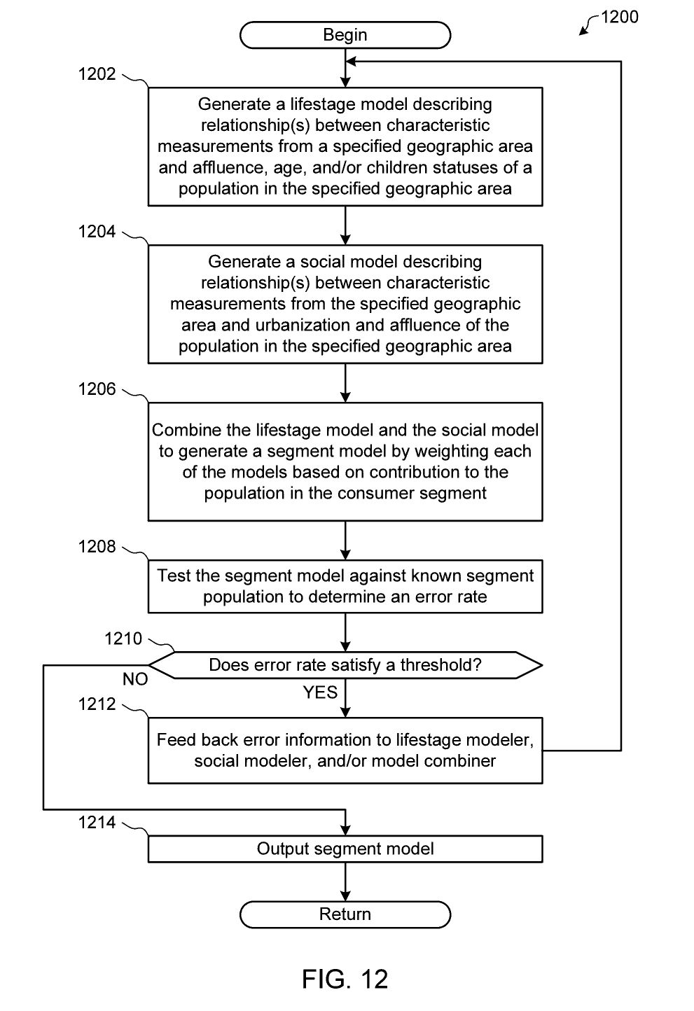

FIG. 12 is a flowchart representative of example machine readable instructions 1200 which may be executed to implement the example consumer segment determiner 100 of FIG. 1 to determine a relationship between a population of a consumer segment and collected measurements of a set of characteristics. The example instructions 1200 of FIG. 12 may be executed to implement block 1004 of FIG. 10 to determine a relationship between the first measurements and consumer segment information for a training geographic area.

The example lifestage modeler 804 of FIG. 8 generates a lifestage model 808 describing relationship(s) between the characteristic measurements 202 for the specified geographic area 104 and affluence, age, and/or children statuses of a population in the specified geographic area (block 1202). For example, the lifestage modeler 804 may model relationship(s) between: a) objects identified from images of the geographic area 104 and affluence, age, and/or children status of a population, b) activities related to the consumer segment identifier 102 and affluence, age, and/or children status of a population, c) consumer information related to the consumer segment identifier 102 and affluence, age, and/or children status of a population, and/or d) economic information related to the consumer segment identifier 102 and affluence, age, and/or children status of a population. The lifestage model 808 reflects a population associated with the affluence, age, and/or children status of the consumer segment identifier 102 and/or a distribution of populations for affluence, age, and/or children status in the specified geographic area.

The example social modeler 806 of FIG. 8 generates a social model 810 describing relationship(s) between characteristic measurements 202 for the specified geographic area 104 and an affluence and urbanicity of a population (block 1204). For example, the social modeler 806 may model relationship(s) between a) objects identified from images of the geographic area 104 and affluence and urbanicity of a population, b) activities related to the consumer segment identifier 102 and affluence and urbanicity of a population, c) consumer information related to the consumer segment identifier 102 and affluence and urbanicity of a population, and/or d) economic information related to the consumer segment identifier 102 and affluence and urbanicity of a population. The social model 810 reflects a population associated with the affluence and urbanicity of the consumer segment identifier 102 and/or a distribution of populations for affluence and urbanicity in the specified geographic area.

The example model combiner 812 of FIG. 8 combines the lifestage model 808 and the social model 810 to generate a segment model 802 by weighting each of the models 808, 810 based on a contribution to the population of the consumer segment (block 1206). For example, the model combiner 812 may apply weights to each of the lifestage model 808 and/or the social model 810 based on the distributions of populations and/or attributes predicted by each of the lifestage model 808 and/or the social model 810.

The example model tester 814 tests the segment model 802 against known consumer segment data 818 to determine an error rate (block 1208). For example, the model tester 814 may input a known set of characteristic measurements into the segment model 802 to obtain an estimated population corresponding to the consumer segment identifier 102. The example model tester 814 then compares the estimated consumer segment population (e.g., consumer segment population predicted by the segment model 802 using the weights) to a known consumer segment population (e.g., a consumer segment population obtained from surveying, sampling, or another ground truth method). The difference between the estimated consumer segment population and the known consumer segment population is an error rate. The error rate for the segment model 802 may be a sum of individual errors calculated for sub-regions in the geographic area that corresponds to the known consumer segment population.

The example model tester 814 determines whether the error rate satisfies a threshold error rate (block 1210). For example, the model tester 814 may determine whether the total error calculated from testing the segment model 802 using the known consumer segment data 818 is more than a threshold error.

When the error rate satisfies a threshold error rate (e.g., when there is at least a threshold error between a consumer segment population calculated from the segment model 802 and the known consumer segment data 818) (block 1210), the example model tester 814 feeds back error information to the lifestage modeler 804, the social modeler 806, and/or the model combiner 812 (block 1212). The error information fed back to the lifestage modeler 804, the social modeler 806, and/or the model combiner 812 may include, for example, a total error for the tested geographic area corresponding to the known consumer segment data 818 and/or localized errors for locations and/or sub-regions within the tested geographic area.

When the error rate does not satisfy the threshold error rate (e.g., when there is less than a threshold error between a consumer segment population calculated from the segment model 802 and the known consumer segment data 818) (block 1210), the example segment modeler 108 outputs the segment model 802 (block 1214). The example segment modeler 108 may output the segment model 802 to the segment estimator 110 for use in estimating a consumer segment population for the consumer segment identifier 102 for which the segment model 802 is generated.

The example instructions 1200 of FIG. 12 then end and return control to a calling function, such as block 1004 of FIG. 10.

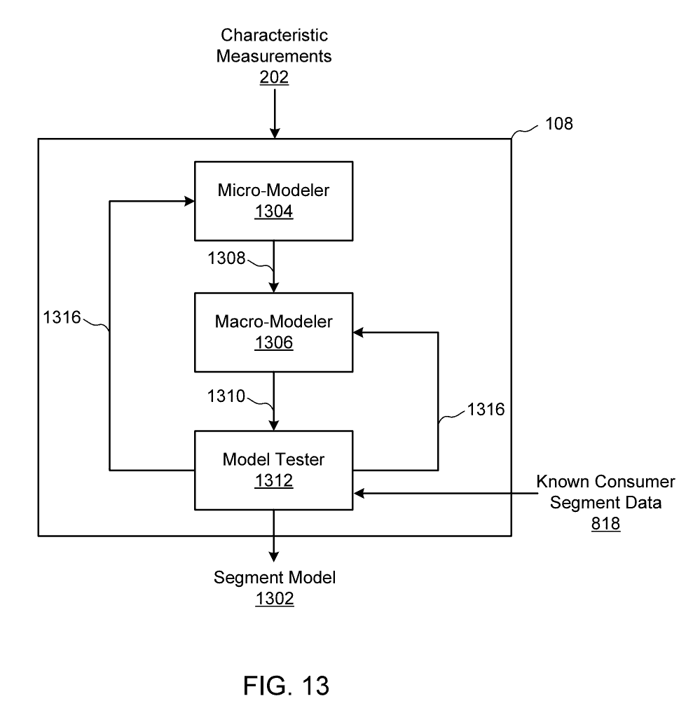

FIG. 13 is a block diagram of another implementation of the example segment modeler 108 of FIG. 1 that may be used to generate a consumer segment model 1302 based on characteristic measurements from the example measurement collector 106 of FIG. 1. The example segment modeler 108 of FIG. 13 includes a micro-modeler 1304 and a macro-modeler 1306. In combination, the example micro-modeler 1304 and the macro-modeler 1306 implement a forest-and-trees approach, in which features at a near-range are used to generate near-range estimates (e.g., tree views) and near-range estimates can be applied to other, similar near-range areas, as well as using far-range features to generate a far-range estimate (e.g., forest views) of the consumer segment population for a specified geographic area.

The example micro-modeler 1304 determines a model of consumer segment population based on elements of the characteristic measurements 202 that are observable and/or applicable on a small geographic scale (e.g., tree-level views in the forest-and-trees approach). For example, the micro-modeler 1304 may determine the effect of observed objects on the consumer segment population within a range of the location of the observed object, such as 100 feet, 500 feet, 1000 feet, or other ranges up to a maximum range.

As an example, the micro-modeler 1304 may determine an effect on a close-range consumer segment population of combinations of observed objects such as the presence of observable children's toys (e.g., basketball hoops, tree houses, etc.), types of buildings and/or open spaces (e.g., single-family homes vs. apartment buildings vs. high-rises), counts of restaurants, coffee shops, and/or boutiques, sales information for consumer segment-related activities, sales information, and/or any other close-range information.

The example micro-modeler 1304 estimates a population of one or more consumer segments (e.g., including the segment corresponding to the consumer segment identifier 102 of FIG. 1) within a sub-region of the specified geographic area using the characteristic measurements 202 corresponding to the sub-region (e.g., based on the geographic locations of the characteristic measurements 202). For example, the micro-modeler 1304 may use a weighting system similar to that described in Equation 1 above. The example micro-modeler 1304 outputs one or more geographic location-based micro-models 1308, which may indicate a population of one or more consumer segments (e.g., a distribution of population among multiple consumer segments) within a range of a geographic location corresponding to the micro-model(s) 1308.

The example macro-modeler 1306 of FIG. 13 receives the micro-model(s) 1308 and the characteristic measurements 202, and generates one or more macro-model(s) 1310 (e.g., forest views in the forest-and-trees approach). For example, the macro-modeler 1306 may duplicate micro-models 1308 for different sub-regions in a specified geographic area, and/or use micro-models from other geographic areas, to copy estimates of consumer segment population(s) to similar sub-regions of the geographic area. For example, if the macro-modeler 1306 receives a micro-model 1308 having a geographic location and distance range that corresponds to first sub-region and identifies a second sub-region that has similar characteristic measurements 202 as the first sub-region, the example macro-modeler 1306 applies the micro-model 1308 to the second sub-region. As an example, the macro-modeler 1306 may determine, based on the micro-model 1308 determined for a first retirement community in a first geographic area, that a second retirement community in a second geographic area has a same or similar population for a specified consumer segment as the first retirement community.

In addition to duplicating the micro-models 1308, the example macro-modeler 1306 applies characteristic measurements that have larger effective distances to the geographic area. For example, while the micro-modeler 1304 may use boutique shops to generate a micro-model 1308 for a geographic sub-region, the example macro-modeler 1306 may use the presence and characteristics of a shopping mall (e.g., products and/or services offered, sales information, etc.) or a car dealership (e.g., make(s) and model(s) offered, sales of different makes and models to determine a consumer segment based on the shopping mall having a tendency to draw people from a farther distance.

In some examples, the macro-modeler 1306 generates the macro-model(s) 1310 for the geographic area based on a summation of populations from multiple micro-models 1308 (e.g., micro-models covering the sub-regions of the geographic area) and/or applying weights based on additional characteristic measurements.

The example micro-modeler 1304 and/or the example macro-modeler 1306 may be at least partially implemented using the lifestage modeler 804, the social modeler 806, and/or the model combiner 812 of FIG. 8.

The example model tester 1312 tests the macro-model(s) 1310 using the known consumer segment data 818 described above with reference to FIG. 8 (e.g., known economic data, sales data, activity data, and/or object data for a geographic area). The example model tester 1312 may be implemented similarly to the model tester 814 described above with reference to FIG. 8. If the example model tester 1312 identifies more than a threshold error between the macro-model 1310 and the known consumer segment data 818, the example model tester 1312 feeds back error information 1316 to the example micro-modeler 1304 and/or the model tester 1312. The example error information 1316 includes errors at individual locations in a geographic area corresponding to the known segment data 818, and portions of the known segment data 818 considered to contribute to the consumer segment information at that location in the known segment data 818. For example, the model tester 1312 may feed back relevant objects, activities, and/or economic data near the location(s) of the error.

When the model tester 1312 determines that the macro-model 1310 has less than a threshold error, the example model tester 1312 outputs the model as the segment model 1302. For example, the segment modeler 108 may output the segment model 1302 to the segment estimator 110 of FIG. 1 for use in generating the consumer segment estimation 114.

While example an manner of implementing the segment modeler 108 of FIG. 1 is illustrated in FIG. 13, one or more of the elements, processes and/or devices illustrated in FIG. 13 may be combined, divided, re-arranged, omitted, eliminated and/or implemented in any other way. Further, the example micro-modeler 1304, the example macro-modeler 1306, the example model tester 1312 and/or, more generally, the example segment modeler 108 of FIG. 13 may be implemented by hardware, software, firmware and/or any combination of hardware, software and/or firmware. Thus, for example, any of the example micro-modeler 1304, the example macro-modeler 1306, the example model tester 1312 and/or, more generally, the example segment modeler 108 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example micro-modeler 1304, the example macro-modeler 1306, and/or the example model tester 1312 is/are hereby expressly defined to include a tangible computer readable storage device or storage disk such as a memory, a digital versatile disk (DVD), a compact disk (CD), a Blu-ray disk, etc. storing the software and/or firmware. Further still, the example segment modeler 108 of FIG. 1 may include one or more elements, processes and/or devices in addition to, or instead of, those illustrated in FIG. 13, and/or may include more than one of any or all of the illustrated elements, processes and devices.

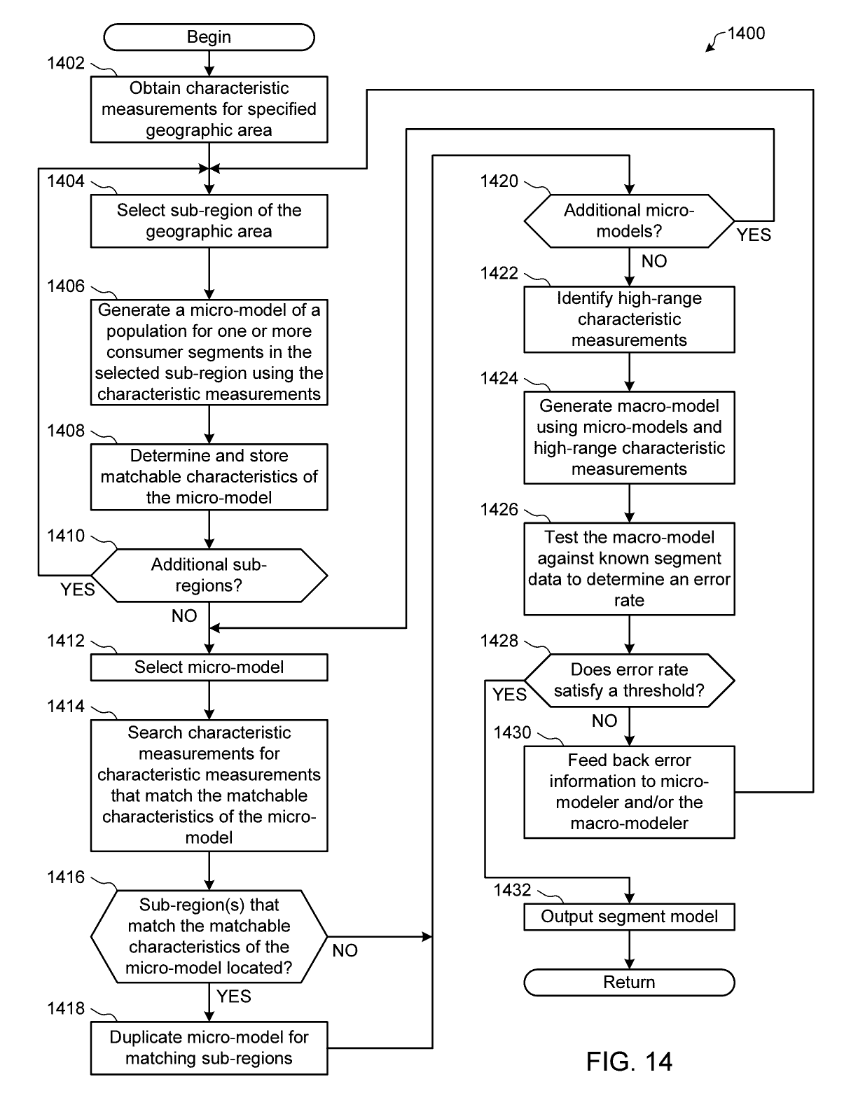

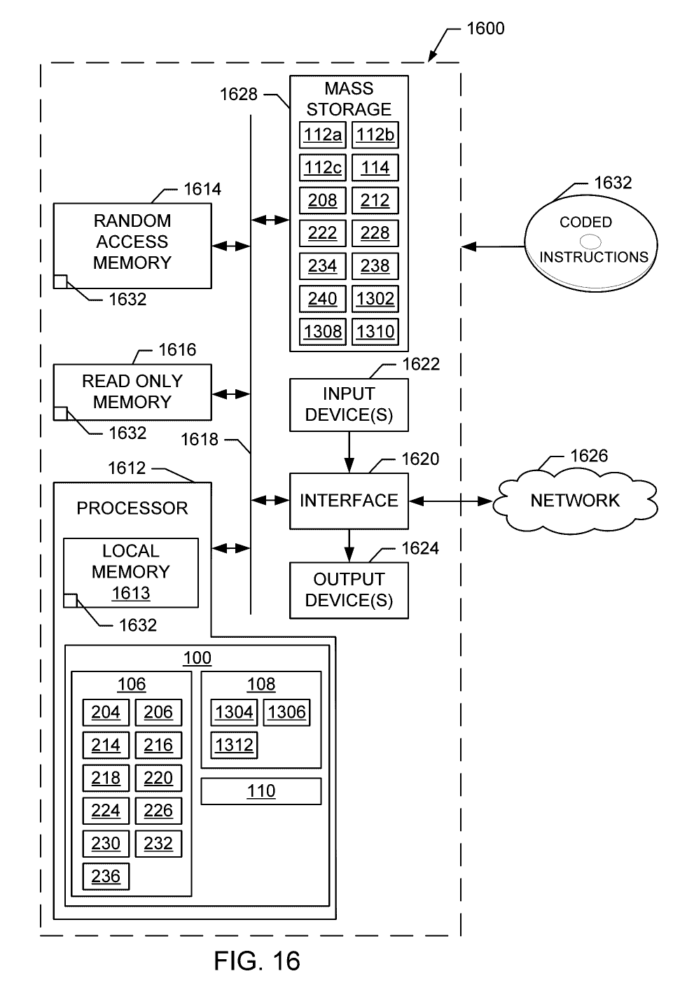

A flowchart representative of example machine readable instructions for implementing the segment modeler 108 of FIG. 1 is shown in FIG. 14. In this example, the machine readable instructions comprise program(s) for execution by a processor such as the processor 1612 shown in the example processor platform 1600 discussed below in connection with FIG. 16. The program(s) may be embodied in software stored on a tangible computer readable storage medium such as a CD-ROM, a floppy disk, a hard drive, a digital versatile disk (DVD), a Blu-ray disk, or a memory associated with the processor 1612, but the entire program(s) and/or parts thereof could alternatively be executed by a device other than the processor 1612 and/or embodied in firmware or dedicated hardware. Further, although the example program(s) are described with reference to the flowcharts illustrated in FIG. 14, many other methods of implementing the example segment modeler 108 may alternatively be used. For example, the order of execution of the blocks may be changed, and/or some of the blocks described may be changed, eliminated, or combined.

As mentioned above, the example processes of FIG. 14 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). Additionally or alternatively, the example processes of FIG. 14 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information).

FIG. 14 is a flowchart representative of example machine readable instructions 1400 which may be executed to implement the example consumer segment determiner 100 of FIG. 1 to determine a relationship between a population of a consumer segment and collected measurements of a set of characteristics. The example instructions 1400 of FIG. 14 may be executed to implement the example segment modeler 108 of FIG. 13.

The example segment modeler 108 (e.g., at the micro-modeler 1304 of FIG. 13) obtains characteristic measurements (e.g., the characteristic measurements 202 of FIG. 2) for a specified geographic area (block 1402). For example, the segment modeler 108 may obtain the characteristic measurements 202, such as count(s) and/or type(s) of objects related to the consumer segment identifier 102 counted from collected image, count(s) and/or type(s) of activities, characterizations or estimates of economic capacity, and/or sales information for products and/or services, from the measurement collector 106 of FIGS. 1 and/or 2.

The example micro-modeler 1304 selects a sub-region of the specified geographic area (e.g., the geographic area corresponding to the geographic area identifier 104, from which the characteristic measurements 202 were generated) (block 1404). The micro-modeler 1304 generates a micro-model of a population for one or more consumer segments (e.g., including the segment identified by the consumer segment identifier 102) in the selected sub-region, using the characteristic measurements 202 (block 1406). For example, the micro-modeler 1304 may generate the micro-model 1308 to include estimates of a population of one or more consumer segments (e.g., including the segment corresponding to the consumer segment identifier 102 of FIG. 1) within a sub-region of the specified geographic area using the characteristic measurements 202 corresponding to the sub-region (e.g., based on the geographic locations of the characteristic measurements 202). An example of estimating the population is based on combinations of observed objects such as the presence of observable children's toys (e.g., basketball hoops, tree houses, etc.), types of buildings and/or open spaces (e.g., single-family homes vs. apartment buildings vs. high-rises), counts of restaurants, coffee shops, and/or boutiques, sales information for consumer segment-related activities, sales information, and/or any other close-range information.

The example micro-modeler 1304 determines and stores matchable characteristics of the micro-model 1308 (block 1408). For example, the micro-modeler 1304 may determine observable objects, traits of observable objects (e.g., colors, shapes, and/or sizes of residential housing) and/or other characteristic measurements that may be used to match the sub-region represented by the micro-model 1308 to other sub-regions.

The micro-modeler 1304 determines whether there are additional sub-regions to model (block 1410). If there are additional sub-regions to model (block 1410), control returns to block 1404 to select another sub-region.

When there are no more sub-regions to model (block 1410), the example macro-modeler 1306 of FIG. 13 selects one of the micro-models 1308 generated by the micro-modeler 1304 (block 1412). The macro-modeler 1306 searches the characteristic measurements 202 for characteristic measurements 202 that match the matchable characteristics of the micro-model 1308 (block 1414). For example, the macro-modeler 1306 may determine whether at least a threshold number and/or type of the characteristic measurements 202 are within an area having an upper size limit (e.g., an area no bigger than a maximum area).

The macro-modeler 1306 determines whether any sub-regions that match the matchable characteristics of the selected micro-model 1308 have been located (block 1416). For example, the macro-modeler 1306 may determine a match based on at least a threshold number of characteristic measurements 202 in an area of the specified geographic area matching the stored matchable characteristics of the micro-model 1308, where some matching characteristic measurements 202 may be more heavily weighted toward a match than others. If any sub-regions that match the matchable characteristics of the selected micro-model 1308 have been located (block 1416), the example macro-modeler 1306 duplicates the selected micro-model 1308 for the matching sub-region(s) (block 1418). For example, the macro-modeler 1306 may generate a second micro-model 1308 having a geographic location based on the area that includes the matching characteristic measurements 202.

After duplicating the micro-model 1308 (block 1418), or if no sub-regions that match the matchable characteristics of the selected micro-model 1308 have been located in the specified geographic area (block 1416), the example macro-modeler 1306 determines whether there are additional micro-models 1308 (block 1420). If there are additional micro-models 1308 (block 1420), control returns to block 1412 to select another of the micro-models.

When there are no additional micro-models 1308 (block 1420), the example macro-modeler 1306 identifies high-range characteristic measurements from the characteristic measurements 202 (block 1422). For example, the macro-modeler 1306 may determine that certain identified objects, activities, economic information, and/or sales information has a higher range of effect on the population of the specified consumer segment.

The example macro-modeler 1306 generates a macro-model 1310 using the micro-models 1308 and any high-range characteristic measurements (block 1424). For example, the macro-modeler 1306 may sum the distributions of populations for one or more consumer segments according to the micro-models 1308, and/or weight the micro-models 1308 prior to summation using the high-range characteristic measurements.

The example model tester 1312 tests the macro-model 1310 against the known consumer segment data 818 to determine an error rate (block 1426). For example, the model tester 1312 may compare the population of a specified consumer segment predicted by the macro-model 1310 to the population of the specified consumer segment determined from known consumer segment data 818, and determine the difference as the error rate.

The model tester 1312 determines whether the error rate satisfies a threshold (block 1428). The threshold may be an upper acceptable error threshold. If the error rate satisfies the threshold (block 1428), the example model tester 1312 feeds back error information 1316 to the micro-modeler 1304 and/or to the macro-modeler 1306 (block 1430). The error information 1316 may be, for example, an adjustment to weights used by the micro-modeler 1304 and/or to the macro-modeler 1306. Control then returns to block 1404 to re-generate the macro-model 1310 based further on the error information 1316.

When the error rate does not satisfy the threshold (block 1428), the example model tester 1312 outputs the macro-model 1310 as the segment model 1302 (block 1432). The example instructions 1400 may then end and/or return control to a calling function.

FIG. 15 is a block diagram of an example processor platform 1500 capable of executing the instructions of FIGS. 10, 11, and/or 12 to implement the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example lifestage modeler 804, the example social modeler 806, the example model combiner 812, the example model tester 814 and/or, more generally, the example consumer segment determiner 100 of FIGS. 1, 2, and/or 8. The processor platform 1500 can be, for example, a server, a personal computer, or any other type of computing device.

The processor platform 1500 of the illustrated example includes a processor 1512. The processor 1512 of the illustrated example is hardware. For example, the processor 1512 can be implemented by one or more integrated circuits, logic circuits, microprocessors or controllers from any desired family or manufacturer.

The example processor 1512 of FIG. 15 implements the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example lifestage modeler 804, the example social modeler 806, the example model combiner 812, the example model tester 814 and/or, more generally, the example consumer segment determiner 100 of FIGS. 1, 2, and/or 8.

The processor 1512 of the illustrated example includes a local memory 1513 (e.g., a cache). The processor 1512 of the illustrated example is in communication with a main memory including a volatile memory 1514 and a non-volatile memory 1516 via a bus 1518. The volatile memory 1514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1516 may be implemented by flash memory and/or any other desired type of memory device. Access to the main memory 1514, 1516 is controlled by a memory controller.

The processor platform 1500 of the illustrated example also includes an interface circuit 1520. The interface circuit 1520 may be implemented by any type of interface standard, such as an Ethernet interface, a universal serial bus (USB), and/or a PCI express interface.

In the illustrated example, one or more input devices 1522 are connected to the interface circuit 1520. The input device(s) 1522 permit(s) a user to enter data and commands into the processor 1512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1524 are also connected to the interface circuit 1520 of the illustrated example. The output devices 1524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1520 of the illustrated example, thus, typically includes a graphics driver card, a graphics driver chip or a graphics driver processor.

The interface circuit 1520 of the illustrated example also includes a communication device such as a transmitter, a receiver, a transceiver, a modem and/or network interface card to facilitate exchange of data with external machines (e.g., computing devices of any kind) via a network 1526 (e.g., an Ethernet connection, a digital subscriber line (DSL), a telephone line, coaxial cable, a cellular telephone system, etc.).

The processor platform 1500 of the illustrated example also includes one or more mass storage devices 1528 for storing software and/or data. Examples of such mass storage devices 1528 include floppy disk drives, hard drive disks, compact disk drives, Blu-ray disk drives, RAID systems, and digital versatile disk (DVD) drives. The example mass storage devices 1528 of FIG. 15 may store one or more of the example data sources 112a-112c, the example consumer segment estimation 114 (e.g., one or more heat maps, tables, etc.), the example aerial image repository 208, the example ground level image repository 212, the example segment table 222, the example activity database 228, the example sales data repository 234, the example consumer data repository 238, the example segment model 802, the example lifestage model 808, and/or the example social model 810 of FIGS. 1, 2, and/or 8.

The coded instructions 1532 of FIGS. 10, 11, and/or 12 may be stored in the mass storage device 1528, in the volatile memory 1514, in the non-volatile memory 1516, and/or on a removable tangible computer readable storage medium such as a CD or DVD.

FIG. 16 is a block diagram of an example processor platform 1600 capable of executing the instructions of FIGS. 10, 11, and/or 14 to implement the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example micro-modeler 1304, the example macro-modeler 1306, the example model tester 1312 and/or, more generally, the example consumer segment determiner 100 of FIGS. 1, 2, and/or 13. The processor platform 1600 can be, for example, a server, a personal computer, or any other type of computing device.

The processor platform 1600 of the illustrated example includes a processor 1612. The processor 1612 of the illustrated example is hardware. For example, the processor 1612 can be implemented by one or more integrated circuits, logic circuits, microprocessors or controllers from any desired family or manufacturer.

The example processor 1612 of FIG. 16 implements the example measurement collector 106, the example segment modeler 108, the example segment estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example segment table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example micro-modeler 1304, the example macro-modeler 1306, the example model tester 1312 and/or, more generally, the example consumer segment determiner 100 of FIGS. 1, 2, and/or 8.

The processor 1612 of the illustrated example includes a local memory 1613 (e.g., a cache). The processor 1612 of the illustrated example is in communication with a main memory including a volatile memory 1614 and a non-volatile memory 1616 via a bus 1618. The volatile memory 1614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1616 may be implemented by flash memory and/or any other desired type of memory device. Access to the main memory 1614, 1616 is controlled by a memory controller.

The processor platform 1600 of the illustrated example also includes an interface circuit 1620. The interface circuit 1620 may be implemented by any type of interface standard, such as an Ethernet interface, a universal serial bus (USB), and/or a PCI express interface.

In the illustrated example, one or more input devices 1622 are connected to the interface circuit 1620. The input device(s) 1622 permit(s) a user to enter data and commands into the processor 1612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1624 are also connected to the interface circuit 1620 of the illustrated example. The output devices 1624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1620 of the illustrated example, thus, typically includes a graphics driver card, a graphics driver chip or a graphics driver processor.

The interface circuit 1620 of the illustrated example also includes a communication device such as a transmitter, a receiver, a transceiver, a modem and/or network interface card to facilitate exchange of data with external machines (e.g., computing devices of any kind) via a network 1626 (e.g., an Ethernet connection, a digital subscriber line (DSL), a telephone line, coaxial cable, a cellular telephone system, etc.).

The processor platform 1600 of the illustrated example also includes one or more mass storage devices 1628 for storing software and/or data. Examples of such mass storage devices 1628 include floppy disk drives, hard drive disks, compact disk drives, Blu-ray disk drives, RAID systems, and digital versatile disk (DVD) drives. The example mass storage devices 1628 of FIG. 16 may store one or more of the example data sources 112a-112c, the example consumer segment estimation 114 (e.g., one or more heat maps, tables, etc.), the example aerial image repository 208, the example ground level image repository 212, the example segment table 222, the example activity database 228, the example sales data repository 234, the example consumer data repository 238, the example segment model 1302, the example micro-model 1308, and/or the example macro-model 1310 of FIGS. 1, 2, and/or 8.

The coded instructions 1632 of FIGS. 10, 11, and/or 14 may be stored in the mass storage device 1628, in the volatile memory 1614, in the non-volatile memory 1616, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method, comprising:
recognizing, with a processor using a first computer vision technique, a first type of object in a first image of a first area, the first type of object being associated with a consumer segment;
obtaining first measurements of a first set of characteristics for the first area, the first set of characteristics being associated with the consumer segment;
determining, with the processor, a first relationship between a first population of the consumer segment in the first area and the first measurements of the first set of characteristics;
recognizing, with the processor using at least one of the first computer vision technique or a second computer vision technique, the first type of object in a second image of a second area;
obtaining second measurements of a second set of characteristics for the second area; and
determining, with the processor, a second population of the consumer segment in the second area based on applying the first relationship to the second measurements.

2. A method as defined in claim 1, wherein the first image is a ground-level image of a point of interest within the first area, and the recognizing of the first type of object includes recognizing the first type of object that is not recognizable from an aerial view of the point of interest.

3. A method as defined in claim 2, further including:
recognizing a second type of object in an aerial image of the first area, the second type of object being associated with the consumer segment; and
obtaining third measurements of the first set of characteristics for the first area, the first set of characteristics being associated with the consumer segment and including the second type of object, and the determining of the first relationship between the first population of the consumer segment in the first area and the first measurements of the first set of characteristics being based on the third measurements.

4. A method as defined in claim 3, wherein the determining of the first relationship includes looking up a combination of objects, including the first type of object, in a database of consumer segment information.

5. A method as defined in claim 1, further including:
identifying a set of second objects in an aerial image of the first area, the second objects in the set sharing a common feature identifiable in the aerial image;
determining a similarity metric between the second objects in the set; and
classifying the first area based on the similarity metric, the determining of the first relationship being based on a classification of the first area.

6. A method as defined in claim 1, wherein determining the first relationship includes:
determining a third population in the first area that belongs to a first lifestage group;
determining a fourth population in the first area that belongs to a first social group; and
weighting the third population and the fourth population to determine the first relationship.

7. A method as defined in claim 6, wherein the determining of the third population includes determining a number of people having a specified affluence, a specified age, and a specified children status, the first lifestage group being one of a plurality of non-overlapping lifestage groups.

8. A method as defined in claim 7, wherein the determining of the third population includes determining a distribution of people into the lifestage groups.

9. A method as defined in claim 6, wherein the determining of the fourth population includes determining a number of people having a specified affluence and a specified urbanicity, the first social group being one of a plurality of non-overlapping social groups.

10. A method as defined in claim 1, further including:
identifying, in the first image, multiple objects having different respective object types; and
determining one of multiple consumer segments that most closely matches the multiple objects based on respective sets of objects associated with the consumer segments, the determining of the first relationship being based on the one of the consumer segments.

11. An apparatus, comprising:
a measurement collector to:
recognize, using a first computer vision technique, a first type of object in a first image of a first area, the first type of object being associated with a consumer segment;
obtain first measurements of a first set of characteristics for the first area, the first set of characteristics being associated with the consumer segment;
recognize, using at least one of the first computer vision technique or a second computer vision technique, the first type of object in a second image of a second area; and
obtain second measurements of a second set of characteristics for the second area;
a segment modeler to determine a first relationship between a first population of the consumer segment in the first area and the first measurements of the first set of characteristics; and
a segment estimator to estimate a second population of the consumer segment in the second area based on applying the first relationship to the second measurements.

12. An apparatus as defined in claim 11, wherein the measurement collector includes an aerial image analyzer to recognize the first type of object, the first image being an aerial image of the first area.

13. An apparatus as defined in claim 12, wherein the measurement collector includes a ground level image analyzer to recognize, using at least one of the first computer vision technique, the second computer vision technique, or a third computer vision technique, a second type of object in a third image of the first area, the segment modeler to determine a second relationship between the consumer segment and a combination of the first type of object and second type of object.

14. An apparatus as defined in claim 13, wherein the aerial image analyzer and the ground level image analyzer are, in cooperation, to:
identify a set of second objects in the first image of the first area and a third image of the first area, the second objects in the set sharing a common feature identifiable in the aerial image;
determine a similarity metric between the second objects in the set; and
classify the first area based on the similarity metric, the determining of the first relationship being based on a classification of the first area.

15. An apparatus as defined in claim 11, wherein the segment modeler includes a lifestage modeler to generate a lifestage model that describes a relationship between the first measurements and at least one of a specified affluence, a specified age group, or a specified children status of the first population in the first area.

16. An apparatus as defined in claim 15, wherein the lifestage modeler is to generate the lifestage model to include a distribution of a third population into multiple affluence groups, multiple age groups, and multiple children statuses.

17. An apparatus as defined in claim 11, wherein the segment modeler includes a social modeler to generate a social model that describes a relationship between the first measurements and at least one of a specified affluence or a specified urbanicity of the first population in the first area.

18. An apparatus as defined in claim 17, wherein the social modeler is to generate the social model to include a distribution of a third population into multiple affluence groups and multiple urbancity groups.

19. An apparatus as defined in claim 11, wherein the segment modeler is to determine the first relationship based on distance from a geographic location of at least one of an identified object, an identified activity, or sales information and the first population of the consumer segment.

20. An apparatus as defined in claim 11, wherein the first image of the first area is a commercial street view image and the second image of the second area is obtained from a photo sharing web site, the first image and the second image including geographic information.

21. A tangible computer readable storage medium comprising computer readable instructions which, when executed, cause a processor to at least:
recognize, using a first computer vision technique, a first type of object in a first image of a first area, the first type of object being associated with a consumer segment;
access first measurements of a first set of characteristics for the first area, the first set of characteristics being associated with the consumer segment;
determine a first relationship between a first population of the consumer segment in the first area and the first measurements of the first set of characteristics;
recognize, using at least one of the first computer vision technique or a second computer vision technique, the first type of object in a second image of a second area;
access second measurements of a second set of characteristics for the second area; and
determine a second population of the consumer segment in the second area based on applying the first relationship to the second measurements.

22. A storage medium as defined in claim 21, wherein the first image is a ground-level image of a point of interest within the first area, and the instructions are to cause the processor to recognize the first type of object by recognizing the first type of object that is not recognizable from an aerial view of the point of interest.

23. A storage medium as defined in claim 22, wherein the instructions are further to cause the processor to:
recognize a second type of object in an aerial image of the first area, the second type of object being associated with the consumer segment; and
access third measurements of the first set of characteristics for the first area, the first set of characteristics being associated with the consumer segment and including the second type of object, and the instructions to cause the processor to determine the first relationship between the first population of the consumer segment in the first area and the first measurements of the first set of characteristics based on the third measurements.

24. A storage medium as defined in claim 23, wherein the instructions to cause the processor to determine the first relationship by looking up a combination of objects, including the first type of object, in a database of consumer segment information.

25. A storage medium as defined in claim 21, wherein the instructions are further to cause the processor to:
identify a set of second objects in an aerial image of the first area, the second objects in the set sharing a common feature identifiable in the aerial image;
determine a similarity metric between the second objects in the set; and
classify the first area based on the similarity metric, the instructions to cause the processor to determine the first relationship based on a classification of the first area.

26-30. (canceled)
